(19) United States
(12) Patent Application Publication
(10) Pub. No.: US 2026/0348924 A1
(43) Pub. Date: Nov. 5, 2026

(54) CUSTOMIZABLE PLATFORM FOR COUPLED RADIOHPLC-TLC ANALYSIS AND RELATED METHODS

(71) Applicant: CORNELL UNIVERSITY, Ithaca, NY (US)

(72) Inventors: James Michael KELLY, New York, NY (US); Anja Simone WACKER, New York, NY (US)

(21) Appl. No.: 19/547,361

(22) Filed: Feb. 23, 2026

Related U.S. Application Data
(60) Provisional application No. 63/761,550, filed on Feb. 21, 2025.

(51) Int. Cl. G01N 30/62; G01N 30/00; G01N 30/02

(52) U.S. Cl. CPC G01N 30/62; G01N 2030/027; G01N 2030/77

(57) ABSTRACT

The present disclosure relates to a platform device for scanning HPLC fractions with a radio-thin layer chromatography (radioTLC) scanner and methods of assessing purity of a radio-labeled compound comprising a decay chain.

This application claims the benefit of U.S. Provisional Patent Application Ser. No. 63/761,550, filed Feb. 21, 2025, which is hereby incorporated by reference in its entirety.

### FIELD OF THE INVENTION

The present disclosure relates to a platform device for scanning HPLC fractions with a radio-thin layer chromatography (radioTLC) scanner and methods of assessing purity of a radio-labeled compound comprising a decay chain.

### BACKGROUND OF THE INVENTION

Targeted alpha therapy (TAT), in which alpha particle-emitting radionuclides are selectively delivered to tumors, is emerging as an effective strategy to improve response and prolong survival for patients with metastasized cancer (Kratochwil et al., “Targeted α-Therapy of Metastatic Castration-Resistant Prostate Cancer with ²²⁵Ac-PSMA-617: Swimmer-Plot Analysis Suggests Efficacy Regarding Duration of Tumor Control,” J. Nucl. Med. 59:795-802 (2018); Kratochwil et al., “Dosing²²⁵ Ac-DOTATOC In Patients with Somatostatin-Receptor-Positive Solid Tumors: 5-Year Follow-Up of Hematological and Renal Toxicity,” Eur. J. Nucl. Med. Mol. Imaging. 49:54-63 (2021); Zacherl et al., “First Clinical Results for PSMA-Targeted α-Therapy Using²²⁵ Ac-PSMA-I&T in Advanced-mCRPC Patients,” J. Nucl. Med. 62:669-674 (2021); Delpassand et al., “Targeted α-Emitter Therapy with ²¹²Pb-DOTAMTATE for the Treatment of Metastatic SSTR-Expressing Neuroendocrine Tumors: First-in-Humans Dose-Escalation Clinical Trial,” J. Nucl. Med. 63:1326-1333 (2022)).

The improved efficacy of TAT over clinically established and FDA-approved targeted radioligand therapeutics like [¹⁷⁷Lu]Lu-PSMA-617 (Pluvicto®) and [¹⁷⁷Lu]Lu-DOTATATE (Lutathera®) is attributed to the high linear energy transfer (LET) of alpha particles, which deposit large energies (80 keV/μm) over short distances (50-100 μm) (Poty et al., “α-Emitters for Radiotherapy: From Basic Radiochemistry to Clinical Studies—Part 1,” J. Nucl. Med. 59:878-884 (2018)).

Actinium-225 (²²⁵Ac) is an attractive radionuclide for this application because it decays via 6 daughter nuclides to stable ²⁰⁹Bi (t_{1/2}=2.01×10¹⁹ years) by emission of 4 alpha and 2 beta particles. Although this complex decay chain is advantageous in the context of anti-tumor activity, it presents significant challenges to assessing the purity of the labeled compound prior to its administration to patients.

Safe administration of radiopharmaceuticals to human patients requires accurate assessment of their chemical and radiochemical purity (RCP) prior to batch release. For small molecule radiopharmaceuticals, the FDA typically requires part of the quality control to be carried out by high performance liquid chromatography (HPLC) as a simultaneous measure of radiochemical purity and chemical identity through co-administration of a standard. However, HPLC analysis is currently not suitable for real-time assessment of RCP for ²²⁵Ac-labeled radiopharmaceuticals for the following reasons.

First, the activity of ²²⁵Ac (t_{1/2}=9.9 d) is often quantified through its progeny nuclides—primarily ²²¹Fr (t_{1/2}=4.8 min, E_{γ}=218 keV) and ²¹³Bi (t_{1/2}=45.6 min, E_{γ}=440 keV), the main emitters of gamma radiation detectable by most gamma detectors (Kelly et al., “A Suitable Time Point for Quantifying the Radiochemical Purity of ²²⁵Ac-Labeled Radiopharmaceuticals,” EJNMMI Radiopharm. Chem. 6:38 (2021)). However, the chromatographic separation disrupts the secular equilibrium of ²²⁵Ac with its progeny nuclides complicating its quantification.

Second, the decay of ²²⁵Ac to ²²¹Fr releases the latter from the chelating moiety due to a recoil energy >100 keV. This results in the presence of unbound progeny nuclides, which will cause additional peaks in the chromatogram (Kruijff et al., “The In Vivo Fate of ²²⁵Ac Daughter Nuclides Using Polymersomes as a Model Carrier,” Sci. Rep. 9:1-13 (2019)).

Third, depending on the chelator conjugated to the (small molecule) targeting vector and the time elapsed after the end of synthesis, the chromatogram may also contain additional peaks of other radiometal complexes, i.e., of ²¹³Bi, formed during the synthesis or, in some cases, by recomplexation of daughter nuclides.

Fourth, a typical flow cell gamma detector used for HPLC cannot distinguish between photons (or alpha or beta particles) of different energies. Yet, because of the different half-lives of ²²⁵Ac and its progeny nuclides as well as the differences in abundance of the detectable emitted gammas, the individual isotopes may be detected with different efficiencies. Therefore, even if full separation of all components of the complex product mixture of the ²²⁵Ac-radiopharmaceutical could be achieved chromatographically, the relative peak integrals may not reflect the true proportion of species present in the analyte.

Consequently, release of ²²⁵Ac-labeled radiopharmaceuticals for administration to patients has typically been based on assessment of radiochemical purity by radio-thin layer chromatography (radioTLC) (Feuerecker et al., “Activity and Adverse Events of Actinium-225-PSMA-617 in Advanced Metastatic Castration-Resistant Prostate Cancer After Failure of Lutetium-177-PSMA, Eur. Urol. 79:343-350 (2021); Kratochwil et al., “225Ac-PSMA-617 for PSMA-Targeted α-Radiation Therapy of Metastatic Castration-Resistant Prostate Cancer,” J. Nucl. Med. 57:1941-1944 (2016)).

The main information obtained by this method is the amount of 225 Ac bound to the radiopharmaceutical, with a first estimate possible as early as 2 h after the end of development (Kelly et al., “A Suitable Time Point for Quantifying the Radiochemical Purity of ²²⁵Ac-Labeled Radiopharmaceuticals,” EJNMMI Radiopharm. Chem. 6:38 (2021)).

To date, the quantification of other radiolabeled impurities as well as confirmation of the chemical identity and purity by this method remains a challenge.

To meet the requirements of regulatory agencies such as the FDA, techniques to retrospectively reconstruct the HPLC radiochromatogram by continuous fraction collecting during the analytical HPLC run are currently being explored. The most widespread method to quantify the activity in the individual fractions is the use of automated gamma counting, which has been reported by several groups. The counting window may either be narrowed around the photon emissions of ²²¹Fr or ²¹³Bi in order to start counting at 30 minutes or 4-6 hours after the end of the HPLC run, respectively, or an open window count may be used at secular equilibrium (Abou et al., “Radiopharmaceutical Quality Control Considerations for Accelerator-Produced Actinium Therapies,” Cancer Biother. Radiopharm. 37:355-363 (2022); Hooijman et al., “Implementing Ac-225 Labelled Radiopharmaceuticals: Practical Considerations and (Pre-)Clinical Perspectives,” EJNMMI Radiopharm. Chem. 9:9 (2024)).

When fractions are collected at a suitable sampling rate, the reconstructed chromatogram provides a more accurate assessment of radiochemical purity than is possible by TLC methods. However, depending on the number of fractions collected, gamma counting may not be completed for a couple of hours, and, consequently, this method is currently recommended as a post-release assessment.

Another recent study demonstrated the possibility of determining RCP for [²²⁵Ac]Ac-PSMA-617 by a coupled HPLC-radioTLC approach (Ahn & Belanger, “Automated Radiolabeling and Handling of 177Lu- and 225Ac-PSMA-617 Using a Robotic Pipettor,” J. Label Compd. Radiopharm. 67:111-115 (2024)). HPLC fractions were transferred by robot to 5 TLC plates scanned for 10-30 min per plate at secular equilibrium. The RCP calculated by this method was comparable to the RCP obtained from gamma counting. However, a major limitation of using radioTLC to quantify the activity in the fractions collected from the HPLC analysis is the low amount of analyte that may be transferred to a TLC plate for analysis.

The present disclosure is directed to overcoming these and other deficiencies in the art.

### SUMMARY

One aspect of the present disclosure relates to a platform device for scanning HPLC fractions with a radio-thin layer chromatography (radioTLC) scanner. The platform device includes a moving stage and a disposable insert, where the disposable insert comprises a plurality of wells capable of receiving aliquots of HPLC fractions, and where the disposable insert is configured to fit inside the moving stage.

Another aspect of the present disclosure relates to a method of assessing purity of a radio-labeled compound comprising a decay chain. This method involves subjecting a sample comprising a radio-labeled compound comprising a decay chain to HPLC analysis to produce a collection of fractions and an HPLC chromatogram; applying an aliquot from one or more of the fractions to a platform device as described herein; and subjecting the platform device to a radioTLC scanner to construct an HPLC radiochromatogram to identify the radio-labeled compound isolated from impurities in the sample.

A further aspect of the present disclosure relates to a method of assessing purity of a radio-labeled compound comprising a decay chain. This method involves subjecting a sample comprising a radio-labeled compound comprising a decay chain to HPLC analysis to produce a collection of fractions and an HPLC chromatogram; and subjecting an aliquot from one or more of the fractions to a radioTLC scanner to construct an HPLC radiochromatogram to identify the radio-labeled compound isolated from impurities in the sample.

In some embodiments, the present disclosure is directed to overcoming limitations in the art and improving, e.g., the quality control (QC) of ²²⁵Ac-labeled radiopharmaceuticals for preclinical experiments. In some embodiments, this involves a specialized insert (e.g., customizable, 3D printed insert) that enables the reconstruction of an HPLC chromatogram from a single radioTLC scan. Described herein are parameters for assessing the utility of this approach for performing pre-release quality control (QC) for ²²⁵Ac-labeled radiopharmaceuticals. Such parameters include, without limitation, the limits of detection (LOD) and quantification (LOQ), analysis time, and peak resolution. As a proof-of-concept, the ability of the coupled HPLC-radioTLC method using the customized insert is used to quantify small ²²⁵Ac-labeled radiochemical impurities present in a product mixture.

### BRIEF DESCRIPTION OF THE DRAWINGS

FIG. 1 is a perspective view of one embodiment of a platform device for scanning HPLC fragments with a radioTLC scanner according to devices and methods of the present disclosure.

FIG. 2 is a perspective view of one embodiment of a disposable insert to be used with a platform device as described herein. The disposable insert is sized to fit into a slot in a stage in the platform device.

FIGS. 3A-3B are schematic illustrations of embodiments of a top view of a platform device (FIG. 3A) and a bottom view of a platform device (FIG. 3B) showing flat surfaces of the stage of the platform device from a top view (FIG. 3A) and an underside view (FIG. 3B).

FIG. 4 is a top view of one embodiment of a platform device without a cover showing structural alignment of a plurality of wells running from a first end of the stage to a second end of the stage.

FIG. 5 is a schematic illustration of a side view of a disposable insert as described herein, showing the depth of individual wells and their relative alignment.

FIG. 6 illustrates a side view of one embodiment of a cover, which may be used to cover a disposable insert to protect the purity of the contents in wells of the disposable insert.

FIG. 7 is a bottom view of one embodiment of a cover comprising a rubber edging.

FIG. 8 is a top view of an embodiment of a platform device showing the disposable insert with wells positioned in the stage along the length of the stage.

FIG. 9 is a bottom view illustrating one embodiment of a cover containing rubber edging running along the entire outer edge of the cover.

FIG. 10 is an illustration of one embodiment of a platform device in perspective view that contains a disposable insert comprising wells.

FIG. 11 illustrates a platform device with a disposable insert positioned in a radioTLC scanner device.

FIGS. 12A-12T are graphs showing the limit of detection and correlation between the injected and the recovered activity.

FIGS. 13A-13F are graphs showing fraction collection interval.

FIGS. 14A-14D are graphs showing peak detection and separation using a custom-made disposable insert for a TLC scanner as described herein.

FIGS. 15A-15O show detection of an artificial degradation product. [

FIGS. 16A-16L are graphs showing time dependence of the reconstructed 225Ac-specific radiochromatograms.

FIGS. 17A-17D are graphs showing determination of the limits of detection and quantification at a scanning speed of 0.125 mm/sec using the custom TLC stage and insert (FIG. 17A). Reconstructed HPLC chromatogram of 5 kBq (FIG. 17B) and 10 kBq (FIG. 17D) [²²⁵Ac]Ac-RPS-063 at a sampling rate of 10 sec.

FIGS. 18A-18B are graphs showing peak separation as a function of distance between individual wells.

FIGS. 19A-19C are graphs showing a reconstructed chromatogram of [²²⁵Ac]Ac-RPS-063 15 min (FIG. 19A), 120 min (FIG. 19B) and 48 h (FIG. 19C) after the end of the HPLC run at a sampling rate of 10 sec.

FIGS. 20A-20C are graphs showing signal-to-noise (S/N) ratios derived from injections of varying activities of [²²⁵Ac]Ac-RPS-063. FIG. 20A shows a representative reconstructed radiochromatogram generated by gamma counting of 84×5 s and 6×30 s fractions collected from a 200 Bq injection on the HPLC. S/N ratios derived from injections ranging from 100 Bq to 100 kBq are reported in the table. Counting was performed using the 180-240 keV energy window and the experiment was performed in triplicate. FIG. 20B shows a representative reconstructed radiochromatogram generated by phosphor imaging of the HPLC fractions collected following a 1 kBq injection. S/N ratios derived from injections ranging from 100 Bq to 100 kBq are reported in the table. Imaging was performed following a 10 min exposure on the phosphor screen and experiments were performed in triplicate. FIG. 20C shows a representative radiochromatogram acquired from a 5 kBq injection on the HPLC. The adjoining table reports S/N ratios acquired from injections ranging from 200 Bq to 10 kBq. The experiment was performed in triplicate.

FIGS. 21A-21B are graphs showing the effect of analysis time on quantification of RCP using gamma counting. FIG. 21A shows reconstructed radiochromatograms acquired by gamma counter using the 180-240 keV energy window at 1 h (top) and 24 h (bottom) after collection of HPLC fractions imaging times. RCP values are reported in the accompanying table. FIG. 21B shows reconstructed radiochromatograms acquired at the same time points by counting using the 350-450 keV energy window.

FIGS. 22A-22C are graphs showing results of a pilot study evaluating the ability of coupled HPLC and gamma counting and coupled HPLC and phosphor imaging to resolve two radiolabeled products. The activity of a purified sample of [²²⁵Ac]Ac-RPS-063 was measured at equilibrium and 50 kBq aliquots were separated. Prior to injection on the HPLC column, 500 Bq (1% by activity; FIG. 22A), 2.5 kBq (5% by activity; FIG. 22B), or 5 kBq (10% by activity; FIG. 22C) [²²⁵Ac]Ac-PTI-105 was added. The mixtures were injected and fractions collected at 5 s intervals from 0-7 min and 30 s intervals from 7-10 min. The relative area of the peak corresponding to [²²⁵Ac]Ac-PTI-105 was determined from the HPLC radiochromatogram and the reconstructed radiochromatograms generated by gamma counting and phosphor imaging of the collected fractions. Gamma counting was performed at full secular equilibrium using the 180-240 keV energy window. Phosphor imaging was performed at full secular equilibrium after a 5 min exposure on the phosphor screen. Values in parenthesis represent the relative proportions of [²²⁵Ac]Ac-RPS-063 and [²²⁵Ac]Ac-PTI-105 excluding ROI1. ROI=Region-of interest; t_{R}=retention time; n.d.=not detected.

FIGS. 23A-23C are graphs showing calibration curves describing the correlation between activity added and counts detected for the radioTLC. Measurements were taken with a scanning speed of 0.125 mm/s (FIG. 23A), 0.25 mm/s (FIG. 23B), and 0.5 mm/s (FIG. 23C).

FIGS. 24A-24C are graphs showing the effect of analysis time on quantification of RCP using radioTLC scanning. FIG. 24A shows radiochromatograms acquired at the 30 min scan time (left) and the 90 min scan time (right). FIG. 24B shows RCP of [²²⁵Ac]Ac-RPS-063 as a function of analysis time. FIG. 24 C shows the corresponding HPLC radiochromatogram.

FIGS. 25A-25C are graphs showing quantification of a known impurity by coupled HPLC-radioTLC. The coupled method was used to quantify the proportion of [²²⁵Ac]Ac-PTI-105, which was added as 10% (FIG. 25A), 20% (FIG. 25B), or 50% (FIG. 25C) per activity basis. Ten second fractions were collected from the HPLC and spotted in the custom-built insert. The insert was scanned at 0.125 mm/s.

### DETAILED DESCRIPTION

Disclosed herein is a platform device for scanning HPLC fractions with a radio-thin layer chromatography (radioTLC) scanner and methods of assessing purity of a radio-labeled compound comprising a decay chain.

### DEFINITIONS

Unless otherwise indicated, the definitions and embodiments described in this and other sections are intended to be applicable to all embodiments and aspects of the present disclosure herein described for which they are suitable as would be understood by a person of ordinary skill in the art.

Singular forms “a”, “an”, and “the” include plural references unless the context clearly dictates otherwise. Thus, for example, a reference to “a method” or a “device” includes one or more methods, devices, and/or method steps of the type described herein and/or which will become apparent to a person of ordinary skill in the art upon reading this disclosure.

If used, the term “about” includes being within a statistically meaningful range of a value. Such a range can be within an order of magnitude, such as within 10% or within 5% of a given value or range.

The term “and/or” as used herein means that the listed items are present, or used, individually or in combination. In effect, this term means that “at least one of” or “one or more” of the listed items is used or present.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including”, “involving”, “having”, and their derivatives. The term “consisting of” and its derivatives, as used herein, are intended to be closed terms that specify the presence of the stated features, elements, components, groups, integers, and/or steps, but exclude the presence of other unstated features, elements, components, groups, integers, and/or steps.

The terms “patient”, “individual”, “subject”, and “animal”, if used, are used interchangeably herein and refer to mammals, including, without limitation, human and animals (e.g., cats, dogs, cows, horses, sheep, pigs, etc.). In some embodiments, the subject is a human.

The term “radionuclide” refers to an atom (nuclide) characterized by a specific number of protons and neutrons that is unstable and undergoes spontaneous radioactive decay, accompanied by the emission of ionizing radiation, including but not limited to, alpha particles, beta particles, gamma rays, X-rays, or Auger electrons. The term “radionuclide” encompasses any radioactive isotope of an element, whether naturally occurring or artificially produced, and includes, without limitation, diagnostic, therapeutic, and theranostic radioisotopes suitable for in vivo or in vitro applications. Exemplary alpha-emitting radionuclides include, but are not limited to, actinium-225 (²²¹Ac³⁺), radium-223 (²³³Ra²⁺), bismuth-213 (²¹³Bi³⁺), lead-212 (²¹²Pb²⁺ and/or ²¹²Pb⁴⁺), terbium-149 (¹⁴⁹Tb³⁺), fermium-255 (²⁵⁵Fm³⁺), thorium-227 (²²⁷Th⁴⁺), thorium-226 (²²⁶Th⁴⁺), astatine-211 (²¹¹At⁺), astatine-217 (217At⁺), and uranium-230.

The term “actinium-225” or “²²⁵A),” as used herein, refers to actinium-225 (²²⁵Ac), an alpha emitter, which has been labelled, e.g., to PSMA ligands as ²²⁵Ac-PSMA for targeted alpha therapy (TAT). ²²⁵Ac has a radioactive half-life of 9.9 days and decays to produce four α-particles with an energy of 5.8-8.4 MeV, with a tissue range of up to 85 μm.

Alpha particles are attractive anti-tumor agents as they have a high linear energy transfer (LET) and relatively short tissue length and are able to produce double-strand DNA damage whilst minimizing toxicity to adjacent tissue. In some embodiments, this is a far more favorable cytotoxic agent as compared to β particle emission which mainly results in single strand DNA breaks and a relatively long tissue path length which contributes to its toxicity profile.

The term “half-life” as used herein can refer to either the half-life of a drug or agent, or the half-life of a radioactive substance. In the context of a radioactive decay, “half-life” is the amount of time it takes for half of the radioactive nuclei in a sample to decay into other nuclei (such as a different element or isotope). In the context of a drug or agent, “half-life” refers to the time required for a drug's or an agent's blood or plasma concentration to decrease by one half. This decrease in concentration is a reflection of its excretion or elimination after absorption is complete and distribution has reached an equilibrium or quasi equilibrium state. The half-life of a drug in the blood may be determined graphically off of a pharmacokinetic plot of a drug's blood-concentration time plot, typically after intravenous administration to a sample population. The half-life can also be determined using mathematical calculations that are well known in the art. Further, as used herein the term “half-life” also includes the “apparent half-life” of a drug. The apparent half-life may be a composite number that accounts for contributions from other processes besides elimination, such as absorption, reuptake, or enterohepatic recycling.

The term “active agent” or “drug,” as used herein, refers to any chemical that elicits a biochemical response when administered to a human or an animal. The drug may act as a substrate or product of a biochemical reaction, or the drug may interact with a cell receptor and elicit a physiological response, or the drug may bind with and block a receptor from eliciting a physiological response.

The terms “treat” or “treatment” of a state, disorder, or condition include: (1) preventing, delaying, or reducing the incidence and/or likelihood of the appearance of at least one clinical or sub-clinical symptom of the state, disorder, or condition developing in a subject that may be afflicted with or predisposed to the state, disorder, or condition, but does not yet experience or display clinical or subclinical symptoms of the state, disorder, or condition; or (2) inhibiting the state, disorder, or condition, i.e., arresting, reducing, or delaying the development of the disease or a relapse thereof or at least one clinical or sub-clinical symptom thereof; or (3) relieving the disease, i.e., causing regression of the state, disorder or condition or at least one of its clinical or sub-clinical symptoms. “Treating” can also mean prolonging survival of a patient beyond that expected in the absence of treatment. “Treating” can also mean inhibiting the progression of disease temporarily, or in some embodiments halting the progression of disease permanently in a subject. The benefit to a subject to be treated may be significant or at least perceptible to the subject or to the physician. As used herein the term “therapeutically effective” applied to dose or amount refers to that quantity of a compound or pharmaceutical composition that is sufficient to result in a desired activity upon administration to a subject in need thereof.

### Platform Device

One aspect of the present disclosure relates to a platform device for scanning HPLC fractions with a radio-thin layer chromatography (radioTLC) scanner.

The platform device includes a moving stage and a disposable insert, where the disposable insert comprises a plurality of wells capable of receiving aliquots of HPLC fractions, and where the disposable insert is configured to fit inside the moving stage.

This aspect of the present disclosure can be carried out with any of the aspects or embodiments disclosed herein.

As described herein throughout, the present disclosure relates to using radio-thin layer chromatography (radioTLC) to assess radiochemical purity. By this process, an aliquot of a reaction mixture is spotted on a TLC plate, which is run in a mobile phase that typically causes unbound metal to migrate with the solvent front and the radionuclide (e.g., ²²⁵Ac-labeled radiopharmaceutical) to remain at the origin. The TLC plate is assayed by a Na(I) scintillation detector, e.g., at least 1.5 h after its removal from the mobile phase for quantification of radiochemical purity (Kelly et al., “A Suitable Time Point for Quantifying the Radiochemical Purity of ²²⁵Ac-labeled Radiopharmaceuticals,” EJNMMI Radiopharm. Chem. 6:38 (2021), which is hereby incorporated by reference in its entirety). In the context of a ²²⁵ Ac-labeled radiopharmaceutical, the γ-emissions in the decay of ²²¹Fr and ²¹³Bi are responsible for the overwhelming majority of the signal detected. The time delay between chromatographic separation and analysis of the TLC plate by a suitable TLC scanner allows for the decay of ²²¹Fr and ²¹³Bi present at the time of spotting. This means that the only signal detected at the time of analysis is ²²¹Fr and ²¹³Bi produced from chromatographically separated ²²⁵Ac-labeled products and impurities. These impurities could arise from undesired side reactions or, more probably, through damage caused to the precursor molecule by the highly ionizing ²²⁵Ac, a process known as radiolysis. Under these conditions, the activity at the application point represents the amount of ²²⁵Ac-labeled radiopharmaceutical and the activity at the solvent front represents the unbound ²²⁵Ac.

While the radioTLC method allows a more accurate determination of the radiochemical purity, it cannot be used to determine the chemical purity of the radiopharmaceutical because radioTLC cannot simultaneously collect UV absorbance spectra. Moreover, this method, in its conventional application, is insufficient for accurate measurement of the reaction products because it is not capable of separating intact compound from radiolabeled impurities (as opposed to unbound metal). Lengthy, two-dimensional radioTLC analytical methods may be developed to resolve these impurities and/or degradation products, but it may not be possible to identify the optimal mobile phases for these separations without prior knowledge of the likely radiolytic products. No such methods have thus far been developed or demonstrated to be suitable in the literature or in clinical practice. As such, radioTLC alone is insufficient for robust evaluation of the quality of ²²⁵Ac-labeled radiopharmaceuticals in compliance with regulatory requirements.

The present disclosure is directed to addressing these limitations by coupling analytical HPLC and radioTLC. The concept of collecting fractions from the HPLC and using an alternative piece of analytical equipment to determine the activity in these fractions after, e.g., ²²⁵Ac has reached equilibrium with its daughter, ²²¹Fr, has been discussed (Abou et al., “Radiopharmaceutical Quality Control Considerations for Accelerator-Produced Actinium Therapies,” Cancer Biother. Radiopharm. 37:355-363 (2022); Hooijman et al., “Implementing Ac-225 Labelled Radiopharmaceuticals: Practical Considerations and (Pre-)Clinical Perspectives,” EJNMMI Radiopharm. Chem. 9:9 (2024); Wacker et al., “Assessment of the Radiochemical Purity and Chemical Identity of [²²⁵Ac]Ac-Labeled Radiotherapeutics by TLC and RP-HPLC,” J. Nucl. Med. 65:242479 (2024), which are hereby incorporated by reference in their entirety). The approach uses gamma counting to retroactively construct the radio-chromatogram showing unbound ²²⁵Ac, the ²²⁵Ac-labeled radiopharmaceutical and any ²²⁵Ac-labeled side products. However, this equipment is not easily accessible to every laboratory, and counting and processing the data can be a time- and resource-consuming endeavor. This extends the duration of the quality control (QC) analysis prior to patient administration, which increases the likelihood of radiolysis of the ²²⁵Ac-radiopharmaceutical. Consequently, this increases the risk of administration of an inactive compound with an altered pharmacokinetic profile that exposes the patient to unnecessary and potentially dangerous, doses of radiation. In addition, it increases the volume of materials contaminated with ²²⁵Ac that must be safely and securely stored for decay prior to disposal.

Another proposed solution is to spot individual HPLC fractions on a TLC plate and scan each spot independently to reconstruct the radiochromatogram (Ahn et al., “Automated Radiolabeling and Handling of ¹⁷⁷Lu- and ²²⁵Ac-PSMA-617 Using a Robotic Pipettor,” J. Label Compd. Radiopharm. 67:111-115 (2024), which is hereby incorporated by reference in its entirety). While this method uses equipment that is standard in radiopharmacies and radiopharmaceutical production labs, it is laborious, even with the use of robotic pipetting devices.

The radioTLC methods described herein, in some embodiments using the devices described herein, reduce the time of acquisition and analysis and reduce the amount of radioactive waste produced by the analyses.

In some embodiments, the platform device for scanning HPLC fragments involves a custom designed insert to allow the HPLC radiochromatogram to be reconstructed using radioTLC. It also represents a step towards the automation of the QC process, which is expected to increase the standardization of these assays, improve their reproducibility, and reduce exposure of QC/QA personnel to radiation. Custom-built equipment for radiochemistry and radiopharmacy has emerged over the past 10 years as solutions to the unique challenges presented by this rapidly evolving discipline. Examples of this approach include automated radiosynthesis units (ASUs) that have been developed using a combination of electronic, robotic, and 3D-printed parts to expand the number of clinical-grade radiolabeled probes that can be prepared in a single laboratory (Collins et al., “Production of Diverse PET Probes with Limited Resources: 24 ¹⁸F-labeled Compounds with a Single Radiosynthesizer,” Proc. Natl. Acad. Sci. U.S.A. 114:11309-11314 (2017); Amor-Coarasa et al., “3D-printed Automation for Optimized PET Radiochemistry,” Sci. Adv. 5: eaax4762 (2019); Maurer et al., “Acetuino—A Handy Open-Source Radiochemistry Module for the Preparation of [1-¹¹C]Acetate,” SLAS Technol. 24:321-329 (2019); Klingler & Holland, “Automated Light-induced Synthesis of ⁸⁹Zr-radiolabeled Antibodies for Immune-positron Emission Tomography,” Sci. Rep. 12:668 (2022); Fu et al., “Custom-built Automated Radiosynthesis Platform for Al[¹⁸F]F Radiochemistry and its Application for Clinical Production,” Chem. Eng. J. 456:141080 (2023), which are hereby incorporated by reference in their entirety. These examples highlight the suitability of custom-built approaches to radiopharmaceutical production and QC analysis for production of batches of pre-clinical and clinical applications.

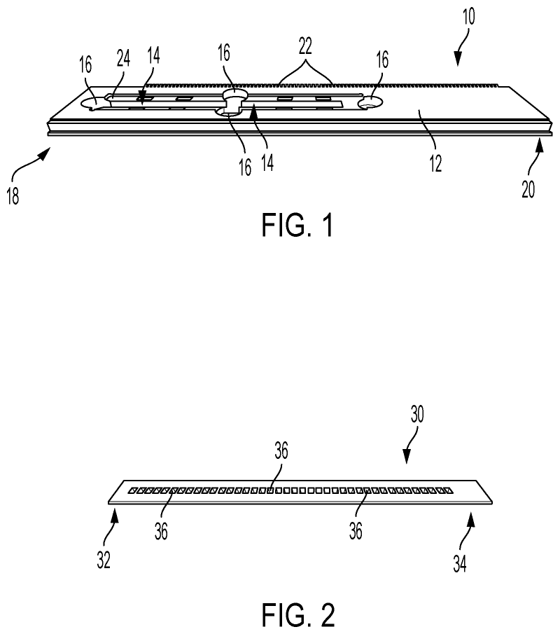

With reference to FIG. 1, illustrated in a perspective view is one embodiment of platform device 10 for scanning HPLC fractions with a radioTLC scanner. Platform device 10 includes stage 12, also referred to as moving stage 12, which is a stage that is passed through a commercially available radioTLC scanner. Platform device 10 also includes slot 14 for accommodating a disposable insert (illustrated in FIG. 2, discussed infra). In the embodiment illustrated in FIG. 1, platform device 10 includes cut-out sections 16 to accommodate insertion and removal of a disposable insert (discussed with reference to FIG. 2, infra). Lower shelf 24 is set slightly below the upper surface of stage 12 to accommodate the disposable insert. Also, in the embodiment illustrated in FIG. 1, platform device 10 has first end 18 and second end 20, with slot 14 running at least part of the length of stage 12 from first end 18 to second end 20. Platform device 10 also includes gear strip 22 to assist with movement of platform device 10 and stage 12 through a radioTLC scanner.

Turning now to FIG. 2, illustrated in perspective view is one embodiment of disposable insert 30, which is sized to fit into slot 14 of stage 12 of platform device 10. Disposable insert 30 includes first end 32 and second end 34 which align generally with first end 18 and second end 20 of platform device 10. Disposable insert 30 is structured to contain a series of wells 36, which allow for fractions collected from an HPLC run to be transferred directly into wells 36.

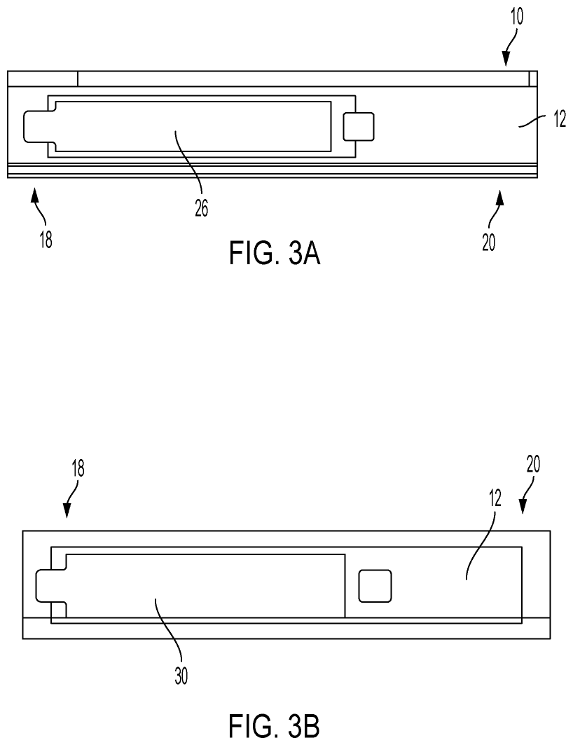

With reference now to FIGS. 3A-3B, illustrated are embodiments of a top view of platform device 10 (FIG. 3A) and a bottom view of platform device 10 (FIG. 3B), showing flat surfaces of stage 12 from a top view (FIG. 3A) and an underside view (FIG. 3B). Also illustrated in FIG. 3A is optional cover 26, which is positioned to cover the exposed top of disposable insert 30 (FIG. 2) when positioned in platform device 10. In the embodiment illustrated in FIG. 3B, insert 30 is shown.

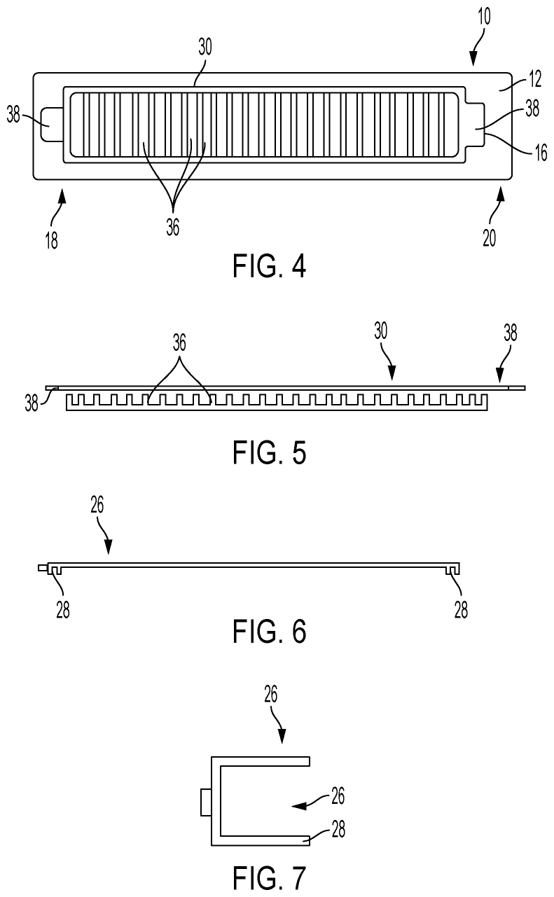

A top view of one embodiment of platform device 10 without a cover 26 is illustrated in FIG. 4, showing the structural alignment of the plurality of wells 36 running from first end 18 of stage 12 to second end 20 of stage 12.

FIG. 5 illustrates a side view of disposable insert 30, showing the depth of wells 36 and handles 38 separate from the wells to assist movement of insert 30 into and out of stage 12 of platform device 10.

In the embodiments illustrated in FIG. 4 and FIG. 5, disposable insert 30 is shown with 24 wells, although any number of wells could be used.

FIG. 6 illustrates a side view of one embodiment of cover 26, which may be used to cover disposable insert 30 to protect the purity of the contents in wells 36 of disposable insert 30. Cover 26 is an optional feature. In some embodiments, cover 26 has rubber edging 28, which is configured to rest against stage 12. A bottom view of cover 26 and rubber edging 28 is illustrated in FIG. 7.

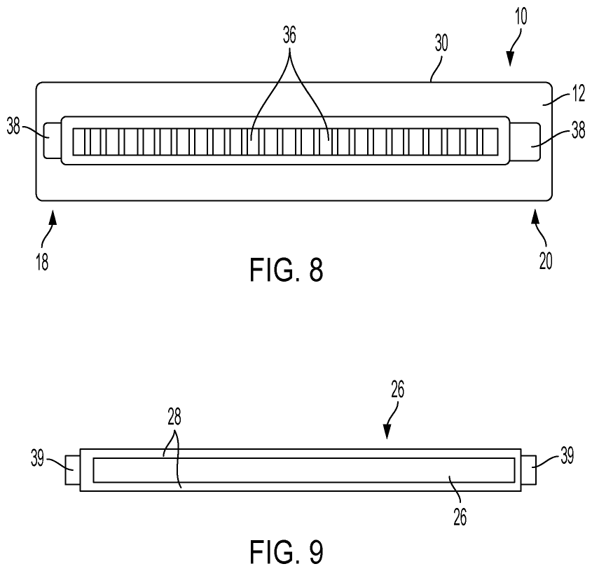

An additional illustration and embodiment of platform device 10 is illustrated in FIG. 8 from a top view. As illustrated, disposable insert 30 with wells 36 is positioned in stage 12 of platform device 10 along the length of stage 12 from first end 18 to second end 20. Handles 38 are positioned on either end of disposable insert 30, away from the wells, to assist with insertion and removal of disposable insert 30 from stage 12.

An additional illustration and embodiment of cover 26 is illustrated in FIG. 9, which is a bottom view of cover 26 showing rubber edging 28 running along the entire outer edge of cover 26. Cover 26 also includes handles 38 to assist with placing and removing cover 26 over disposable insert 30.

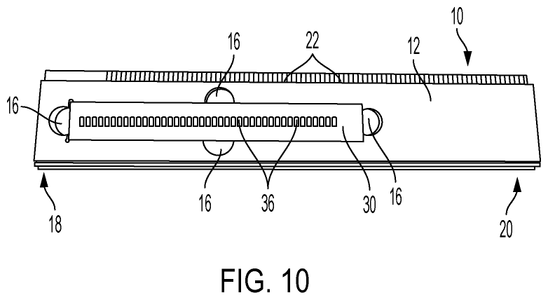

Additional illustrations of embodiments of platform device 10 and disposable insert 30 are illustrated in a perspective view in FIG. 10, which shows disposable insert 30 positioned in platform device 10.

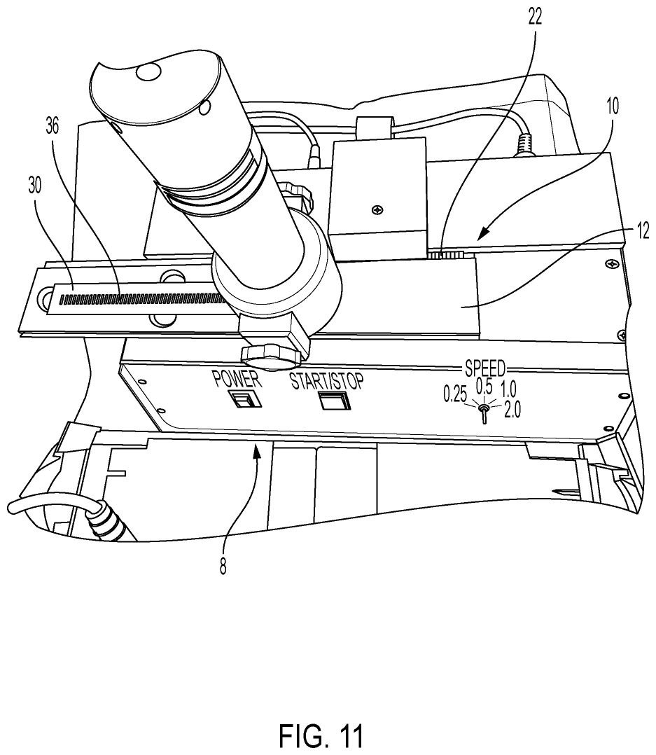

In FIG. 11, platform device 10 with disposable insert 30 positioned therein is shown along with radioTLC scanner 8, as platform device 10 and moving stage 12 move through radioTLC scanner 8.

In some embodiments, platform device 10 and disposable insert 30 are a unique adaptation of a commercially available radioTLC scanner. In its conventional application, a conventional radioTLC scanner is based on the chromatographic separation of a radioactive compound from residual unbound radioisotope using a stationary phase and a mobile phase designed to move the unbound radioisotope from the application point. However, the stationary phase, often silica gel 60, is not typically capable of separating unbound radiometal, the desired radiopharmaceutical, and any radiolabeled impurities at the same time because of the different sizes and interactions of these materials with the solid phase. The present disclosure harnesses the radioTLC scanner's ability to detect spots of radioactivity along a moving stage for the reconstruction of an HPLC radiochromatogram by analyzing the individual fractions of an HPLC run. The moving stages of commercially available radioTLC scanners are not suitable for this purpose as they only allow the analysis of TLC plates of limited length and thickness. These plates are not long enough to allow all HPLC fractions to be spotted with sufficient spatial resolution. The platform device of the present disclosure uses a custom-built radioTLC platform that can be adapted to all major commercially available scanners and to individual uses. As discussed herein throughout, this platform device (e.g., platform device 10 of FIG. 1), has a moving stage (e.g., moving stage 12 of FIG. 1) and an insert (e.g., disposable insert 30 of FIG. 2) with a customizable number and size of wells (e.g., wells 36 of FIG. 2), allows for the fractions collected from the HPLC run to be transferred directly into adjacent wells (e.g., wells 36 of FIG. 2) of the insert (e.g., disposable insert 30 of FIG. 2). When the platform is then passed through the radioTLC scanner at a suitable rate (e.g., 0.1 mm/min or higher or any other suitable rate to accomplish quality scanning), the HPLC radiochromatogram can be retroactively reconstructed.

Additional features of the platform device of the present disclosure (e.g., platform device 10 of FIG. 1) include, for example and without limitation, in some embodiments the platform device has a customizable moving stage (e.g., moving stage 12 of FIG. 1) length. The length of the moving stage can be adjusted to fit the number of HPLC fractions required for the desired time window and resolution of the radiochromatogram.

The moving stage can be designed to fit any radioTLC system and can be 3D printed such that it can hold the disposable insert. The moving stage can be prepared from any materials suitable for 3D printing. Exemplary materials include, without limitation, polylactic acid (PLA), acrylonitrile butadiene styrene (ABS), Nylon, polyethylene terephthalate glycol (PETG), Polyether ether ketone (PEEK), or combinations thereof. In some embodiments, the moving stage is 3D printed using polylactic acid (PLA). In some embodiments, the disposable insert is 3D printed using a combination of polypropylene and nylon.

In some embodiments, the platform device comprises a cover, wherein the cover fits over the insert.

In some embodiments, the platform device comprises a chemically resistant material. Exemplary chemically resistant materials include, without limitation, nylon 12 and polypropylene.

In some embodiments, the disposable insert comprises solvent-resistant materials. In some embodiments, the solvent resistant material is nylon. In some embodiments, each of the plurality of wells is lined with an absorbing material. In some embodiments, the absorbing material is a liquid solidifier.

In addition, in some embodiments, the platform device of the present disclosure can accommodate larger volumes of administration. For example, and without limitation, the sizes of the wells in the disposable insert (e.g., wells 36 of FIG. 2) and spatial separation can be individually tailored to the radiopharmaceutical. In contrast to conventional TLC plates, which can only absorb a few μL of a liquid, the wells (e.g., wells 36 of FIG. 2) of the disposable insert (e.g., disposable insert 30 of FIG. 2) can be customized to hold between 1 μL and 500 μL of any solution, or any amount or range therein. In some embodiments, because the activity typically injected into the HPLC for QC assays is diluted in the mobile phase, the activity concentration in the fractions collected may be low. Thus, larger volumes of the eluate will lead to improved signal-to-noise ratios.

Further, the platform device of the present disclosure permits improved resolution. The ability to customize the number of fractions, their spatial resolution, and the volume (and therefore activity) of the fractions ensures that the radioTLC chromatogram can be developed with maximum resolution.

In some embodiments, each of the wells in the disposable insert is capable of holding between 1 μL and 500 μL of a solution or any amount or range therein. For example, in some embodiments, each of the wells can hold between 1 μL and 20 μL, between 1 μL and 40 μL, between 1 μL and 60 μL, between 1 μL and 80 μL, between 1 μL and 100 μL, between 1 μL and 150 μL, between 1 μL and 200 μL, between 1 μL and 250 μL, between 1 μL and 300 μL, between 1 μL and 350 μL, between 1 μL and 400 μL, between 1 μL and 450 μL, between 10 μL and 20 μL, between 10 μL and 40 μL, between 10 μL and 60 μL, between 10 μL and 80 μL, between 10 μL and 100 μL, between 10 μL and 150 μL, between 10 μL and 200 μL, between 10 μL and 250 μL, between 10 μL and 300 μL, between 10 μL and 350 μL, between 10 μL and 400 μL, between 10 μL and 450 μL, between 10 μL and 500 μL, between 20 μL and 40 μL, between 20 μL and 60 μL, between 20 μL and 80 μL, between 20 μL and 100 μL, between 20 μL and 150 μL, between 20 μL and 200 μL, between 20 μL and 250 μL, between 20 μL and 300 μL, between 20 μL and 350 μL, between 20 μL and 400 μL, between 20 μL and 450 μL, between 20 μL and 500 L, between 50 μL and 100 μL, between 50 μL and 150 μL, between 50 μL and 200 μL, between 50 μL and 250 μL, between 50 μL and 300 μL, between 50 μL and 350 μL, between 50 μL and 400 μL, between 50 μL and 450 μL, between 50 μL and 500 μL, between 100 μL and 150 μL, between 100 μL and 200 μL, between 100 μL and 250 μL, between 100 μL and 300 μL, between 100 μL and 350 μL, between 100 μL and 400 μL, between 100 μL and 450 μL, between 100 μL and 500 μL, between 150 μL and 200 μL, between 150 μL and 250 μL, between 150 μL and 300 μL, between 150 μL and 350 μL, between 150 μL and 400 μL, between 150 μL and 450 μL, between 150 μL and 500 μL, between 200 μL and 250 μL, between 200 μL and 300 μL, between 200 μL and 350 μL, between 200 μL and 400 μL, between 200 μL and 450 μL, between 200 μL and 500 μL, between 250 μL and 300 μL, between 250 μL and 350 μL, between 250 μL and 400 μL, between 250 μL and 450 μL, between 250 μL and 500 μL, between 300 μL and 350 μL, between 300 μL and 400 μL, between 300 μL and 450 μL, between 300 μL and 500 μL, between 350 μL and 400 μL, between 350 μL and 450 μL, between 350 μL and 500 μL, between 400 μL and 450 μL, between 400 μL and 500 μL, or between 450 μL and 500 μL.

Additionally, the platform device has the benefit of reduced waste. For example, in some embodiments, the disposable inserts (e.g., disposable insert 30 of FIG. 2) are 3D printed with solvent-resistant materials and the wells are lined with absorbing material to prevent leakage of the radioactive liquid. Contamination may be further minimized by use of a leak-proof lid for the insert system (discussed infra). After completion of the assay, the insert can be stored for decay and then discarded or incinerated. In some embodiments, the insert occupies a much smaller space than all of the counting tubes that are required for the γ-counter. In some embodiments, the platform is suitable for one-time use under cGMP conditions.

The disposable insert can be 3D printed with the desired number of wells. In some embodiments, the disposable insert comprises 40 wells. In some embodiments, the disposable insert comprises between 10 and 100 wells or any number or range therein. For example, in some embodiments, the disposable insert comprises between 10 and 20 wells, 10 and 40 wells, between 10 and 60 wells, between 10 and 80 wells, between 20 and 40 wells, between 20 and 60 wells, between 20 and 80 wells, between 20 and 100 wells, between 30 and 40 wells, between 30 and 60 wells, between 30 and 80 wells, between 30 and 100 wells, between 40 and 60 wells, between 40 and 80 wells, between 40 and 100 wells, between 50 and 60 wells, between 50 and 80 wells, between 50 and 100 wells, between 60 and 80 wells, between 60 and 100 wells, between 70 and 80 wells, between 70 and 100 wells, or between 80 and 100 wells.

In some embodiments, the platform device (comprising pieces such as the moving stage, the insert, and the cover) can be 3D printed. Any required drawings can be custom-made by computer-aided design (CAD) using appropriate software. Available 3D printing modalities include fused deposition modeling (FDM), also called fused filament fabrication (FFF), stereolithography (SLA), digital light processing (DLP), selective laser sintering (SLS), and multi jet fusion (MJF). The choice of printing material will depend on the compound(s) to be analyzed. Analytical HPLC methods for small molecule, peptide, and peptide-mimetic radiopharmaceuticals typically use mobile phases that include organic and/or acidic solvents. Therefore, the platform device for these compounds may be printed using either SLS or MJF, as these modalities can work with chemically resistant materials like nylon 12 and polypropylene. Because the HPLC analysis of antibodies uses aqueous buffers at neutral pH, platforms suitable for the analysis of ²²⁵Ac-labeled antibodies for radioimmunotherapy may also be made from less resistant material.

On a larger scale (e.g., production of batches >20 units), all parts can also be plastic molded using polypropylene (or a similarly chemically resistant material). The design and drawing of the parts can be done by CAD. In some embodiments, injection molding is the most suitable technique for preparing the parts, but other methods are also available.

As discussed herein throughout, the platform device of the present disclosure can be used to determine the chemical identity and radiochemical purity of a radiopharmaceutical. This can be accomplished by retroactively generating a radiochromatogram for the HPLC analysis of the radiopharmaceutical. In some embodiments, a suitable workflow is as follows.

First, after the end of synthesis, an aliquot of the final product solution containing the ²²⁵Ac-labeled radiopharmaceutical will be drawn and injected into the HPLC for analysis. The amount and activity injected will be dependent on the sensitivity of the UV detector of the HPLC and the limit of detection of the TLC scanner. The analytical column, mobile phase composition, gradient and flow rate, and length of the injection method will be adjusted according to the individual ²²⁵Ac-labeled radiopharmaceutical (or other radionuclide) to be analyzed. Typically, for small molecules, peptides, and peptidomimetics, the column is based on C18 material, flow rates are between 1 and 5 mL/min, a gradient is run using water and acetonitrile with addition of ≤0.1% of an acid, and run times are between 10 min and 30 min.

Second, HPLC fractions will be collected either at regular time intervals (e.g., every 5 s) or at fixed volumes (e.g., every 500 μL) using a fraction collector.

Third, an aliquot of each HPLC fraction (e.g., between about 1 μL and about 500 μL, or any number or range therein, depending on the volume collected per fraction and on the amount of activity injected into the HPLC) will be transferred to adjacent wells of the TLC platform. Each HPLC fraction will correspond to an individual well in the insert.

Fourth, the insert will be loaded onto the mobile stage, covered, and stored until equilibrium is reached between the parent radionuclide and the γ-emitting daughter(s). For example, ²²⁵ Ac-labeled radiopharmaceuticals will be stored for 0.5 h to 2 h, or any time or range therein.

Fifth, the radioTLC chromatogram will be acquired by scanning the insert at a suitable rate (e.g., 0.1 mm/min) based on the number of wells, the distance between them, and the ability to match the retention times of HPLC.

Sixth, the peak areas will be integrated using the software of the TLC scanner to provide the radiochemical purity. This radio-chromatogram can be overlaid with the UV chromatogram of the HPLC to determine the chemical identity of the ²²⁵Ac-labeled radiopharmaceutical.

As discussed supra, the platform device described herein for a TLC reader comprises two parts: the moving stage and an insert with a variable number of wells. A cover or coverslip is also possible to minimize contamination but is not required for the analysis. If the moving stage is custom-made for a TLC reader already available in a radiopharmaceutical production lab, the best way of making it may be by 3D printing. In some embodiments, the process of 3D printing is faster and can be more easily adjusted to the specific needs of a lab. Additionally, in this case the production will only be small scale making the 3D printing the more economical choice. If in the second case the moving stage is produced together with the production of new radioTLC scanners, plastic molding may be a more suitable technique. Then, one or several standardized molds can be created to make one or several different moving stages specifically for the model of the TLC scanner at hand. Additionally, the choice of material in either case will be guided by best suitability for the handling (e.g., chemical resistance, ease of moving through the reader, durability).

In some embodiments, plastic molding is the method of choice for making the insert as a second part of the platform. In some embodiments, the insert is disposable. In some embodiments, cleaning after use is not possible for several reasons. Firstly, the risk of contamination of the personnel cleaning the insert is high and results in additional exposure to radioactivity. Secondly, without the use of aggressive chemicals completely removing a radioactive substance from a surface is difficult and residual radioactivity from a previous analysis could falsify the result of the next analysis. The aggressive cleaning required would therefore reduce the options for materials that can be used to make the insert (i.e., glass, ceramic, stainless steel). This will result in a less cost-effective product. Finally, waiting for the activity to decay would require a large and suitable storage by the lab producing the ²²⁵Ac-radiopharmaceutical as the material would need to be stored for at least 10 half-lives (>100 days for 225 Ac). Additionally, it would increase the requirement for resistance to solvents and ionizing radiation. Therefore, in some embodiments, it is most suitable to produce the insert for single use only. This would also provide the opportunity to produce the insert for cGMP production. Because of the large scale of the production required, plastic molding using a chemically resistant material like polypropylene that can be incinerated after use and radioactive decay is the best and most economical option to produce the insert.

### Methods of Assessing Purity of a Radio-Labeled Compound

Another aspect of the present disclosure relates to a method of assessing purity of a radio-labeled compound comprising a decay chain. This method involves subjecting a sample comprising a radio-labeled compound comprising a decay chain to HPLC analysis to produce a collection of fractions and an HPLC chromatogram; applying an aliquot from one or more of the fractions to a platform device as described herein; and subjecting the platform device to a radioTLC scanner to construct an HPLC radiochromatogram to identify the radio-labeled compound isolated from impurities in the sample.

This aspect of the present disclosure can be carried out with any of the aspects or embodiments disclosed herein.

In some embodiments, the method further comprises storing the platform device until equilibrium is reached between a parent radionuclide present in the decay chain and one or more daughter radionuclide(s) generated from the parent radionuclide, wherein said storing is carried out prior to subjecting the platform device to the radioTLC scanner.

In some embodiments, constructing the HPLC radiochromatogram comprises acquiring a radioTLC chromatogram from the radioTLC scanner, wherein the radioTLC chromatogram comprises one or more peaks corresponding to radioactivity, and comparing the one or more peaks of the radioTLC chromatogram with the HPLC chromatogram to identify the radio-labeled compound.

In some embodiments, the radio-labeled compound is selected from the group consisting of a small molecule, peptide or peptidomimetic radiopharmaceutical, a radio-labeled antibody, a radio-labeled macromolecule, or a radio-labeled nanoparticle.

In some embodiments, the parent radionuclide is selected from the group consisting of ²²⁵Ac, ¹³⁴Ce, ²¹²Pb, and ²²⁷Th.

In some embodiments, applying an aliquot from one or more of the fractions comprises manually transferring an aliquot in the amount of about 1 μL to about 500 μL (or any amount or range therein) from one or more of the fractions to the platform device. In some embodiments, said applying an aliquot from one or more of the fractions comprises an automated transfer of a 1 to 500 μL aliquot from one or more of the fractions to the platform device For example, in some embodiments, said applying comprises the manual or automated transfer of a 1 to 20 μL aliquot, a 1 to 40 μL aliquot, a 1 to 50 μL aliquot, a 1 to 100 μL aliquot, a 1 to 150 μL aliquot, a 1 to 200 μL aliquot, a 1 to 250 μL aliquot, a 1 to 300 μL aliquot, a 1 to 350 μL aliquot, a 1 to 400 μL aliquot, a 1 to 450 L aliquot, 10 to 20 μL aliquot, a 10 to 40 μL aliquot, a 10 to 50 μL aliquot, a 10 to 100 μL aliquot, a 10 to 150 μL aliquot, a 10 to 200 μL aliquot, a 10 to 250 μL aliquot, a 10 to 300 μL aliquot, a 10 to 350 μL aliquot, a 10 to 400 μL aliquot, a 10 to 450 L aliquot, a 10 to 500 μL aliquot, a 20 to 40 μL aliquot, a 20 to 50 μL aliquot, a 20 to 100 μL aliquot, a 20 to 150 μL aliquot, a 20 to 200 μL aliquot, a 20 to 250 μL aliquot, a 20 to 300 μL aliquot, a 20 to 350 μL aliquot, a 20 to 400 μL aliquot, a 20 to 450 μL aliquot, a 20 to 500 μL aliquot, a 50 to 100 μL aliquot, a 50 to 150 μL aliquot, a 50 to 200 μL aliquot, a 50 to 250 μL aliquot, a 50 to 300 μL aliquot, a 50 to 350 μL aliquot, a 50 to 400 μL aliquot, a 50 to 450 μL aliquot, a 50 to 500 μL aliquot, a 100 to 150 μL aliquot, a 100 to 200 μL aliquot, a 100 to 250 μL aliquot, a 100 to 300 μL aliquot, a 100 to 350 μL aliquot, a 100 to 400 μL aliquot, a 100 to 450 μL aliquot, a 100 to 500 μL aliquot, a 150 to 200 μL aliquot, a 150 to 250 μL aliquot, a 150 to 300 μL aliquot, a 150 to 350 μL aliquot, a 150 to 400 μL aliquot, a 150 to 450 μL aliquot, a 150 to 500 μL aliquot, a 200 to 250 μL aliquot, a 200 to 300 μL aliquot, a 200 to 350 μL aliquot, a 200 to 400 μL aliquot, a 200 to 450 μL aliquot, a 200 to 500 μL aliquot, a 300 to 400 μL aliquot, a 300 to 500 μL aliquot, or a 400 to 500 μL aliquot.

In some embodiments, the collection of fractions is obtained by collecting HPLC fractions at regular time intervals using a fraction collector. In some embodiments, the collection of fractions is obtained by collecting HPLC fractions at fixed volumes using a fraction collector.

In some embodiments, said applying an aliquot from one or more of the fractions comprises transferring an aliquot of one of the fractions to a well in the disposable insert and placing the disposable insert into the moving stage.

Another aspect of the present disclosure relates to a method of assessing purity of a radio-labeled compound comprising a decay chain. This method involves subjecting a sample comprising a radio-labeled compound comprising a decay chain to HPLC analysis to produce a collection of fractions and an HPLC chromatogram and subjecting an aliquot from one or more of the fractions to a radioTLC scanner to construct an HPLC radiochromatogram to identify the radio-labeled compound isolated from impurities in the sample.

This aspect of the present disclosure can be carried out with any of the aspects or embodiments disclosed herein.

In some embodiments, the method further comprises bringing a parent radionuclide present in the decay chain and one or more daughter radionuclide(s) generated from the parent radionuclide to equilibrium prior to subjecting to the radioTLC scanner.

In some embodiments, constructing the HPLC radiochromatogram involves acquiring a radioTLC chromatogram from the radioTLC scanner, wherein the radioTLC chromatogram comprises one or more peaks corresponding to radioactivity and comparing the one or more peaks of the radioTLC chromatogram with the HPLC chromatogram to identify the radio-labeled compound.

In some embodiments, the radio-labeled compound is selected from the group consisting of a small molecule, peptide or peptidomimetic radiopharmaceutical, a radio-labeled antibody, a radio-labeled macromolecule, or a radio-labeled nanoparticle.

In some embodiments, the parent radionuclide is selected from the group consisting of ²²⁵Ac, ¹³⁴Ce, ²¹²Pb, and ²²⁷Th.

In some embodiments, subjecting an aliquot from one or more of the fractions comprises applying an aliquot of each fraction to a well in a substrate. In some embodiments, the aliquot comprises about 1 μL to about 500 μL, or any amount or range therein. For example, in some embodiments, the aliquot comprises 1 to 20 μL, 1 to 40 μL, 1 to 50 μL, 1 to 100 μL, 1 to 200 μL, 1 to 300 μL, 1 to 400 μL, 10 to 20 μL, 10 to 40 μL, 10 to 50 μL, 10 to 100 μL, 10 to 200 μL, 10 to 300 μL, 10 to 400 μL, 10 to 500 μL, 20 to 40 μL, 20 to 50 μL, 20 to 100 μL, 20 to 200 μL, 20 to 300 μL, 20 to 400 μL, 20 to 500 μL, 40 to 50 μL, 40 to 100 μL, 40 to 200 μL, 40 to 300 μL, 40 to 400 μL, 40 to 500 μL, 50 to 100 μL, 50 to 200 μL, 50 to 300 μL, 50 to 400 μL, 50 to 500 μL, 100 to 200 μL, 100 to 300 μL, 100 to 400 μL, 100 to 500 μL, 200 to 300 μL, 200 to 400 μL, 200 to 500 μL, 300 to 400 μL, 300 to 500 μL, or 400 to 500 μL.

In some embodiments, said subjecting an aliquot from one or more of the fractions comprises manually transferring an aliquot of about 1 μL to 500 μL (or any amount or range therein) from one or more of the fractions to the substrate. In some embodiments, said subjecting comprises the manual transfer of a 1 to 20 μL, a 1 to 40 μL, a 1 to 50 μL aliquot, a 1 to 100 μL aliquot, a 1 to 150 μL aliquot, a 1 to 200 μL aliquot, a 1 to 250 μL aliquot, a 1 to 300 μL aliquot, a 1 to 350 μL aliquot, a 1 to 400 μL aliquot, a 1 to 450 μL aliquot, 10 to 20 μL aliquot, a 10 to 40 μL aliquot, a 10 to 50 μL aliquot, a 10 to 100 μL aliquot, a 10 to 150 μL aliquot, a 10 to 200 μL aliquot, a 10 to 250 μL aliquot, a 10 to 300 μL aliquot, a 10 to 350 μL aliquot, a 10 to 400 μL aliquot, a 10 to 450 μL aliquot, a 10 to 500 μL aliquot, a 20 to 40 μL aliquot, a 20 to 50 μL aliquot, a 20 to 100 μL aliquot, a 20 to 150 μL aliquot, a 20 to 200 μL aliquot, a 20 to 250 μL aliquot, a 20 to 300 μL aliquot, a 20 to 350 μL aliquot, a 20 to 400 μL aliquot, a 20 to 450 μL aliquot, a 20 to 500 μL aliquot, a 50 to 100 μL aliquot, a 50 to 150 μL aliquot, a 50 to 200 μL aliquot, a 50 to 250 μL aliquot, a 50 to 300 μL aliquot, a 50 to 350 μL aliquot, a 50 to 400 μL aliquot, a 50 to 450 μL aliquot, a 50 to 500 μL aliquot, a 100 to 150 μL aliquot, a 100 to 200 μL aliquot, a 100 to 250 μL aliquot, a 100 to 300 μL aliquot, a 100 to 350 μL aliquot, a 100 to 400 μL aliquot, a 100 to 450 μL aliquot, a 100 to 500 μL aliquot, a 150 to 200 μL aliquot, a 150 to 250 μL aliquot, a 150 to 300 μL aliquot, a 150 to 350 μL aliquot, a 150 to 400 μL aliquot, a 150 to 450 μL aliquot, a 150 to 500 μL aliquot, a 200 to 250 μL aliquot, a 200 to 300 μL aliquot, a 200 to 350 μL aliquot, a 200 to 400 μL aliquot, a 200 to 450 μL aliquot, a 200 to 500 μL aliquot, a 300 to 400 μL aliquot, a 300 to 500 μL aliquot, or a 400 to 500 μL aliquot.

In some embodiments, the collection of fractions is obtained by collecting HPLC fractions at regular time intervals using a fraction collector.

In some embodiments, the collection of fractions is obtained by collecting HPLC fractions at fixed volumes using a fraction collector.

The examples below are intended to exemplify the practice of embodiments of the disclosure but are by no means intended to limit the scope thereof.

### EXAMPLES

### Example 1—Radio-HPLC for ²²⁵Ac-Radiopharmaceuticals: Considerations on the Retrospective Reconstruction of the ²²⁵Ac-Specific Radiochromatogram by Three Different Methods

Targeted alpha therapy (TAT) with [225Ac]Ac-labeled radiopharmaceuticals has demonstrated effectiveness in patients resistant to standard-of-care practices. Further translation to late-stage clinical trials and, ultimately, approval by regulatory agencies, requires advanced quality control (QC) measures to assess the chemical identity and the radiochemical purity (RCP), a task which would ideally be performed by radio-HPLC. However, due to the complex decay scheme of Ac-225, the 225Ac-radiochromatogram is not readily accessible. As disclosed herein, the performance of three different methods was studied—γ-counter, TLC scanner and phosphor imager, by which the 225Ac-radiochromatogram can be obtained.

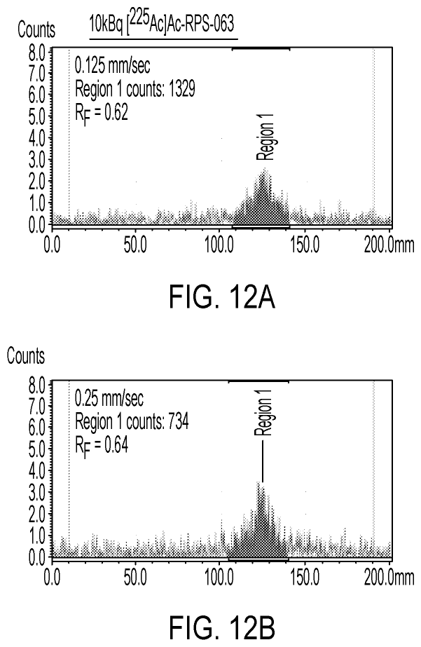

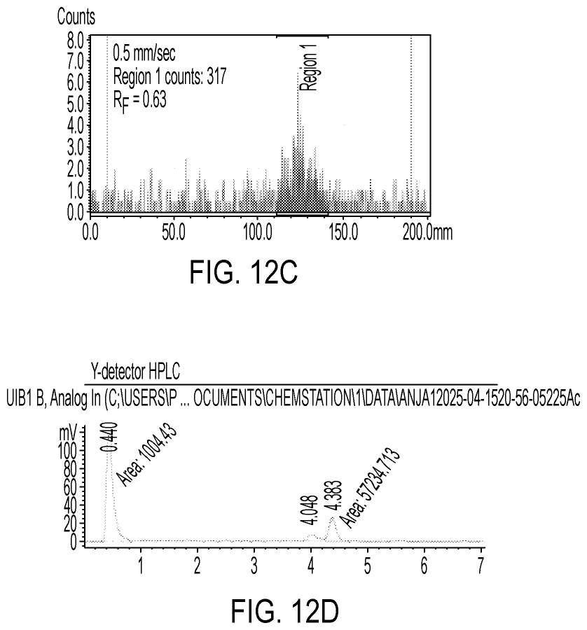

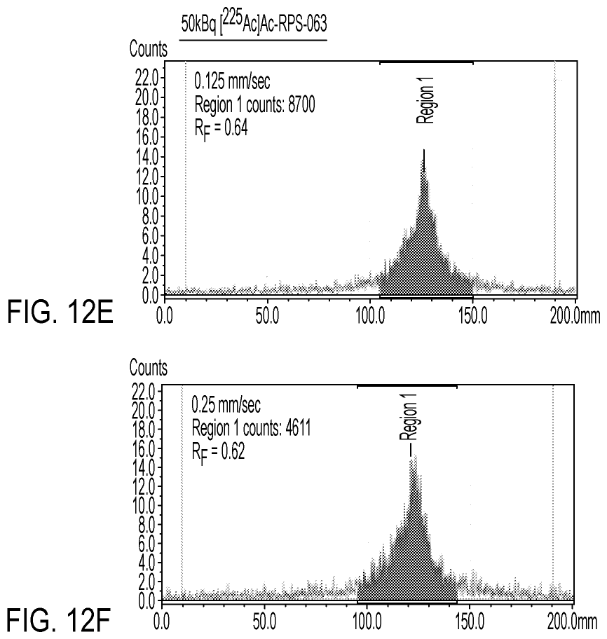

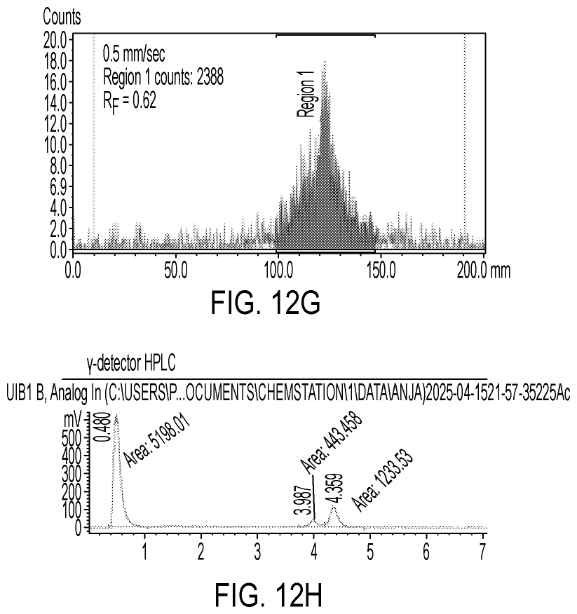

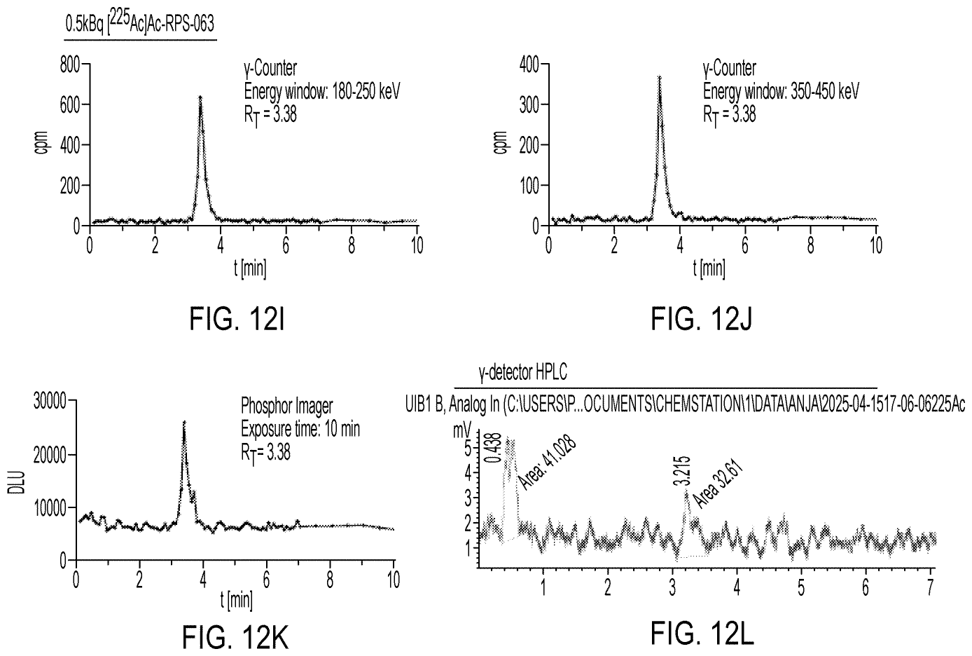

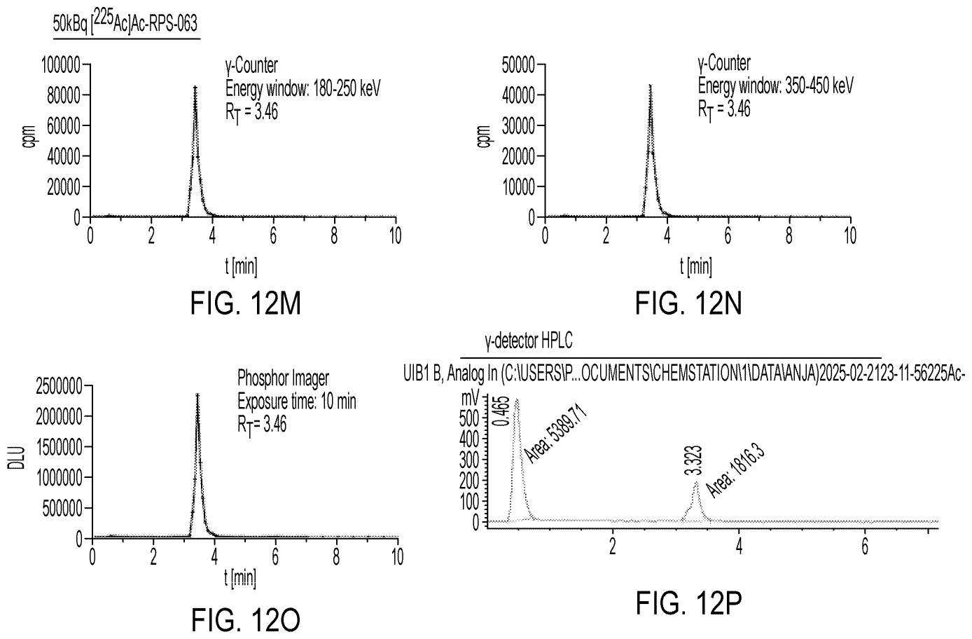

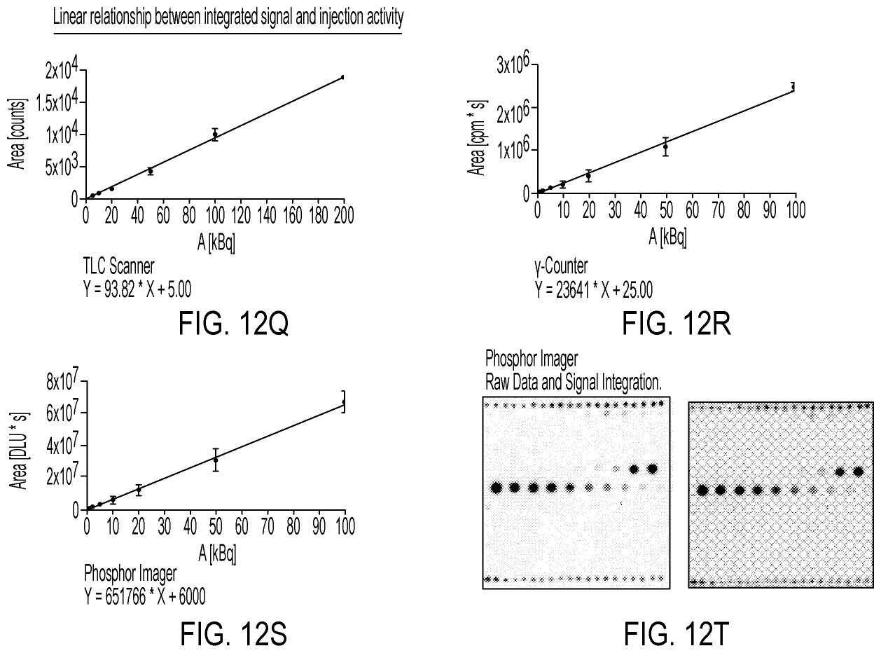

FIGS. 12A-12T show the limit of detection and correlation between the injected and the recovered activity. [225Ac]Ac-RPS-063 was synthesized at 0.05 MBq/mL and passed through a SepPak C18 light cartridge. The final formulation contained 75 mM sodium ascorbate and 0.01 mg/mL DTPA. RCP was confirmed by radio-TLC in 50 mM sodium citrate, pH 5.0 as well as in 1 M NH4OAc (pH 5.5)/DMF 1:1 at the end of synthesis. TLCs were read on a phosphor imager (Cyclone, Perkin Elmer) 2 h after the end of the TLC run. The activity per mL was determined 2 h after the end of synthesis and did not exceed 500-600 kBq/mL to minimize radiolysis. For the HPLC analysis a Symmetry C18, 4.6×50 mm column was connected and 10 mM ammonium formate (A)/acetonitrile (B) used as the mobile phases. Two different gradients were used: 0-1 min 5% B, 1-8 min 5-95% B, 8-9 min 95% B, 9-10 min 95-5% B (phosphor imager and γ-counter) as well as 0-1 min 0% B, 1-2 min 0-13% B, 2-7 min 13-35% B, 7-9 min 35-95% B, 9-10 min 95%, 10-12 min 95-5% B (TLC scanner). Activities from 0.1 kBq (phosphor imager/γ-counter)/5 kBq (TLC scanner) to 100 kBq (phosphor imager/γ-counter)/200 kBq (TLC scanner) were injected and fractions collected every 5 seconds (phosphor imager/γ-counter)/10 seconds (TLC scanner) for the first 7 min, then every 30 seconds for the remaining 3 min. All fractions were collected in γ-counter tubes. To reconstruct the 225Ac-specific radio-chromatogram using the phosphor imager, 1 μL aliquots/fraction were transferred to a TLC plate. For the TLC scanner, 100 μL aliquots/fraction were transferred to the wells of a disposable 3D printed insert (prefilled with solidifier to minimize contamination) that fit into a custom-made 3D printed moving stage (MiniScan, Eckert & Ziegler). All fractions were measured at equilibrium ≥24 h after the end of the HPLC run.

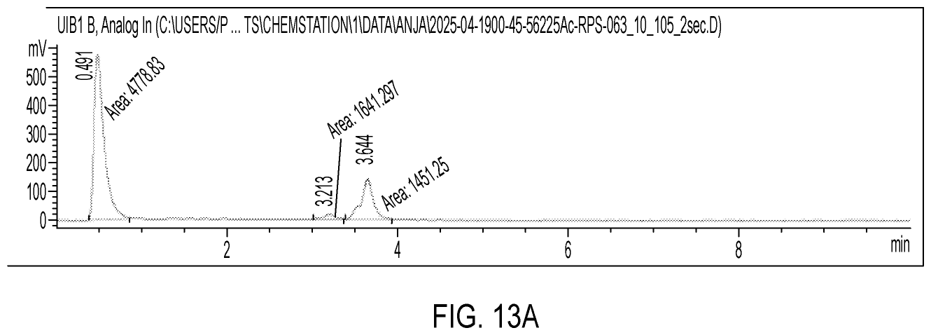

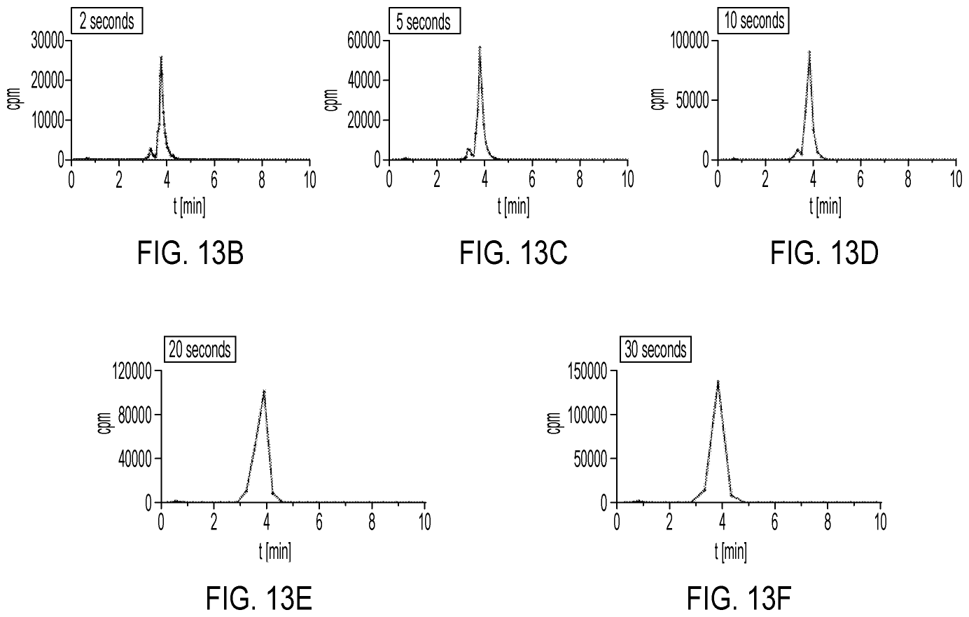

FIGS. 13A-13F show fraction collection interval. [225Ac]Ac-RPS-063 was synthesized and analyzed as described above. The fraction collection interval during the first 7 min was varied from 2 sec to 30 sec and the reconstructed 225Ac-radiochromatogram compared to the radiochromatogram was obtained by the γ-detector of the HPLC.

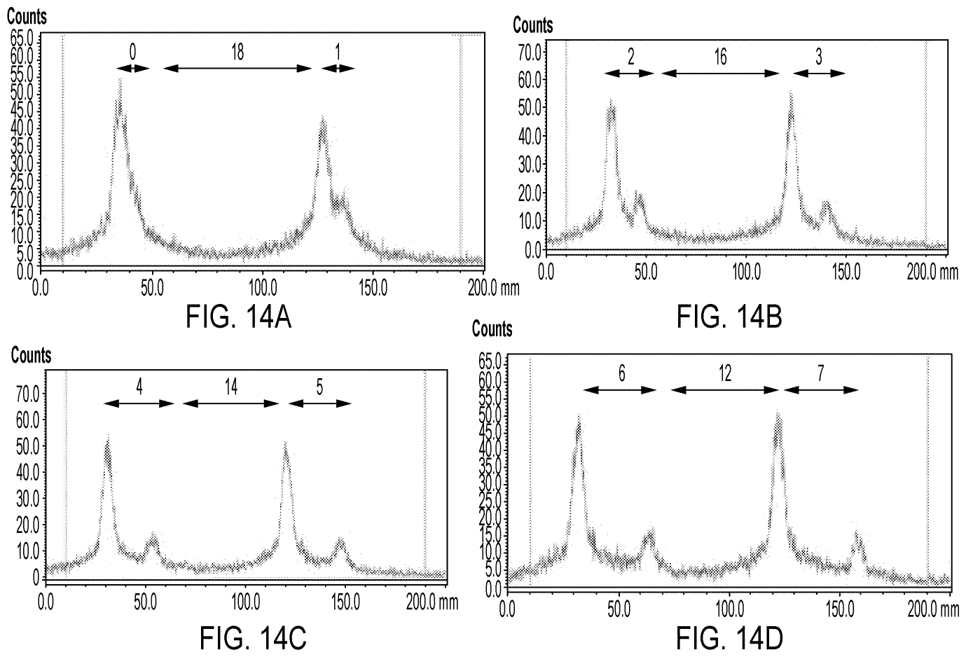

FIGS. 14A-14D show peak detection and separation using the custom-made disposable insert for a TLC scanner. 40 kBq and 10 kBq Ac-225 were transferred to adjacent wells into the 3D printed disposable inserts for the TLC scanner. The distance between the activities was varied from 0 wells to 7 wells. The inserts were scanned at 0.25 mm/sec.

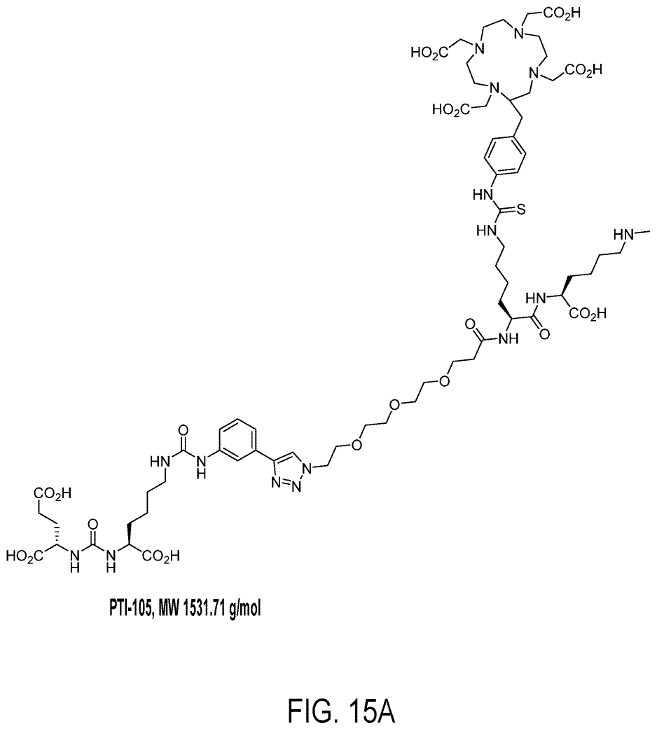

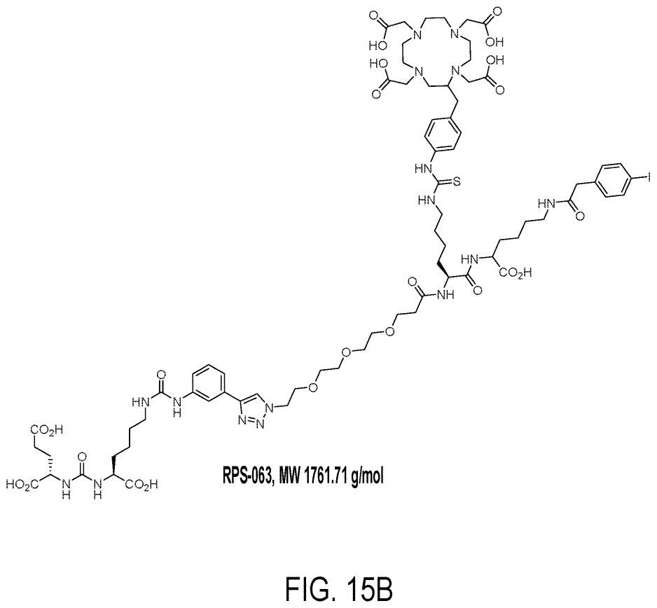

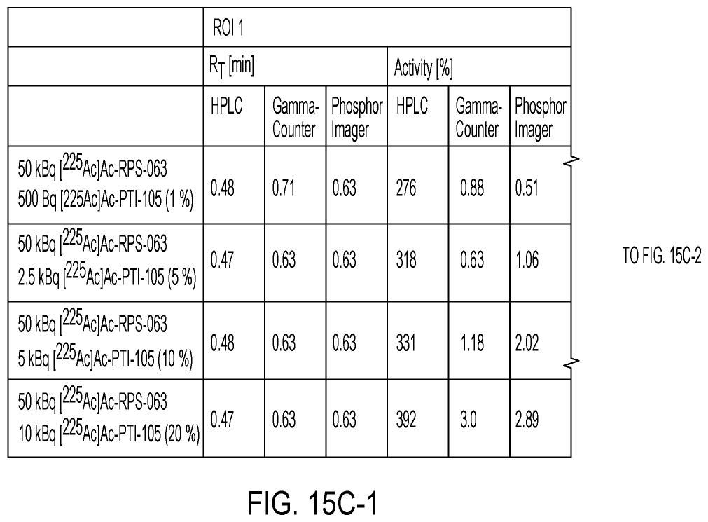

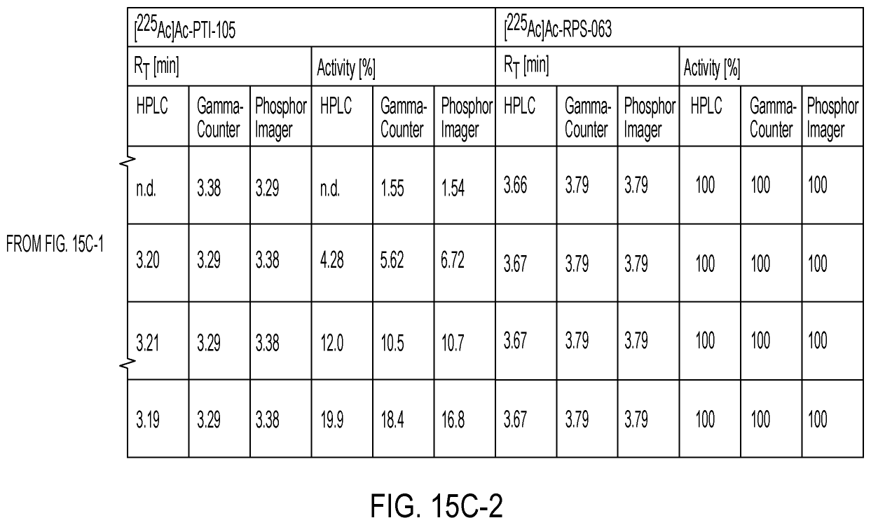

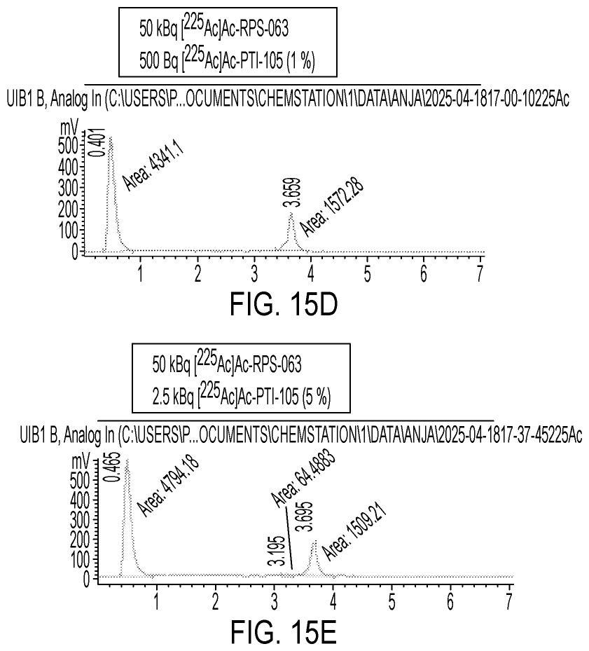

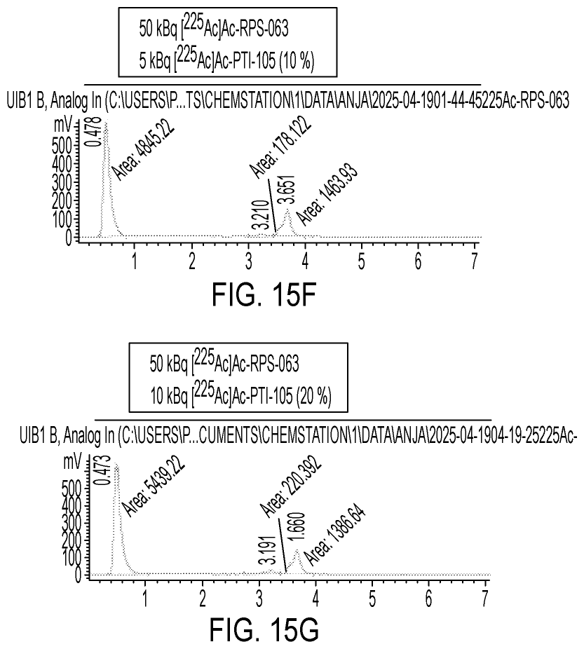

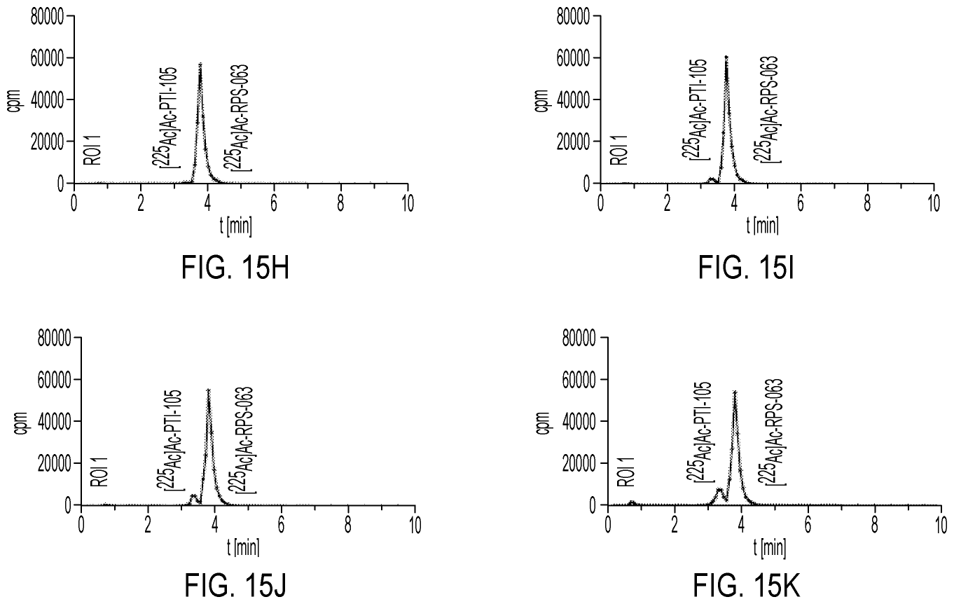

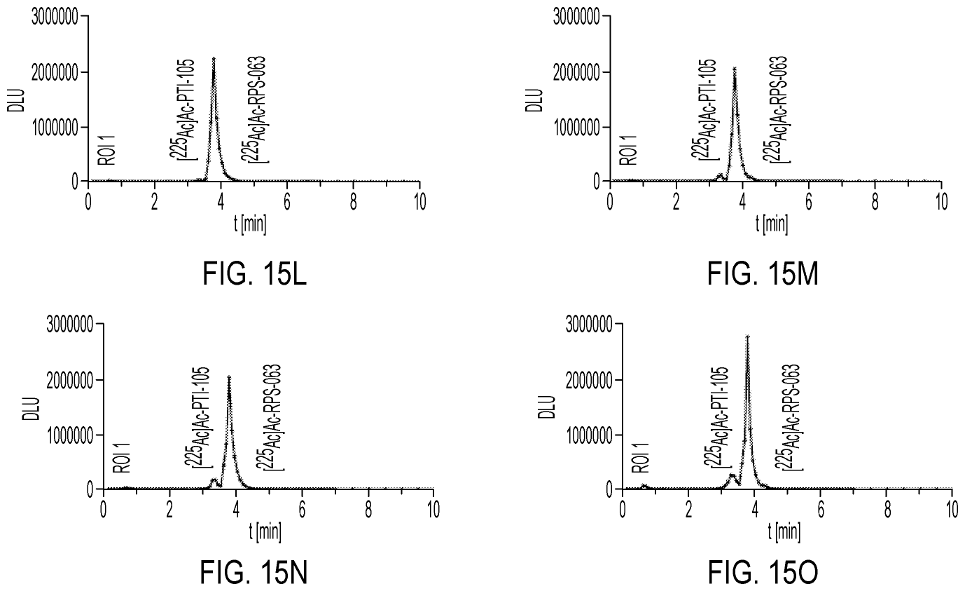

FIGS. 15A-15O show detection of an artificial degradation product. [225Ac]Ac-RPS-063 and [225Ac]Ac-PTI-105 were synthesized as described in FIGS. 12A-12T. After determination of the activities/mL 50 kBq aliquots of [225Ac]Ac-RPS-063 were prepared and [225Ac]Ac-PTI-105 added ranging from 1% (0.5 kBq) to 20% (10 kBq). Both the reconstructed as well as the radio-chromatogram from the γ-counter of the HPLC were integrated and the percentage of recovered [225Ac]Ac-PTI-105 impurity calculated. The calculation was normalized to the area under the curve of the [225Ac]Ac-RPS-063 peak.

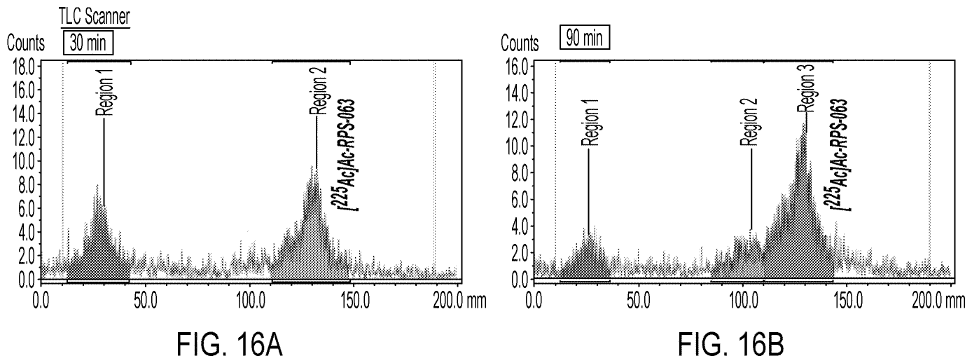

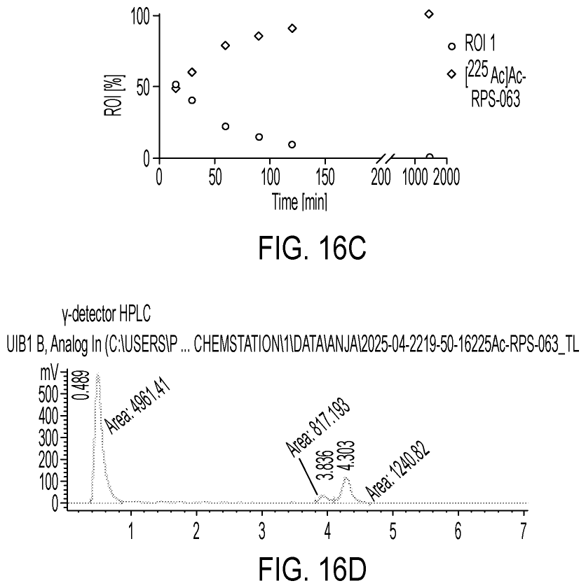

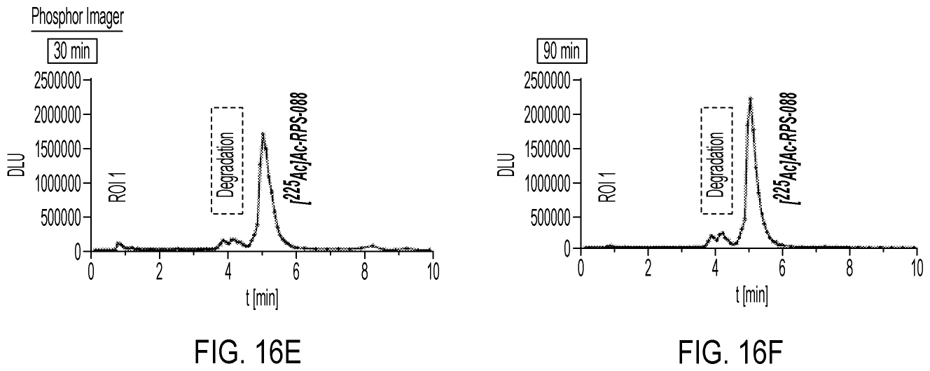

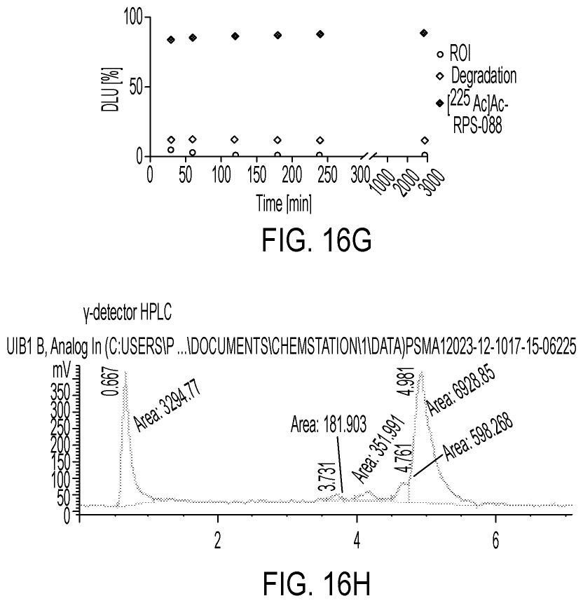

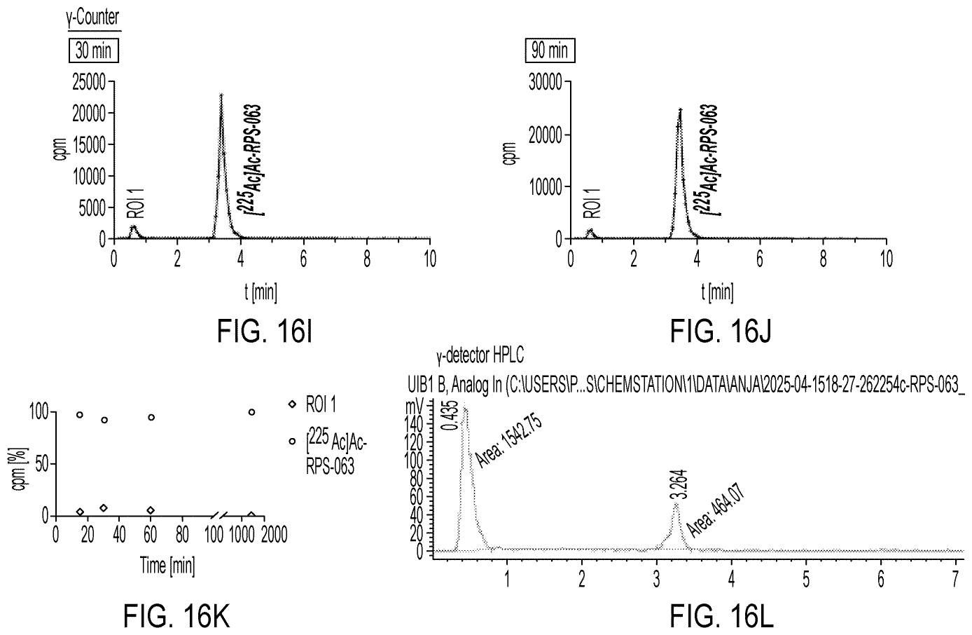

FIGS. 16A-16L show time dependence of the reconstructed 225Ac-specific radiochromatograms. [225Ac]Ac-RPS-063 and [225Ac]Ac-PTI-105 were synthesized and analyzed as described in FIGS. 12A-12T. The collected fractions were first analyzed at 15 min (γ-counter)/30 min (phosphor imager and TLC scanner) after the end of the HPLC run and then repeatedly until equilibrium was reached ≥24 h later.

All three modalities have their respective strengths and weaknesses with respect to retrospectively reconstruct the 225Ac-specific radiochromatogram. Both γ-counter and phosphor imager have demonstrated high sensitivity in detecting injected activities as low as 0.5 kBq while the resolution mainly depends on the fraction collection intervals. However, no software currently exists for the reconstruction of the radiochromatogram, which consequently requires additional time. Moreover, measuring all fractions in the γ-counter is time consuming and not feasible as pre-release QC. The TLC scanner offers a fast and easy alternative, due to both availability as well as the potential to use the included software. Yet, both resolution and sensitivity and resolution are much lower and require the injection of higher activities. All modalities are affected by the disruption of the equilibrium between Ac-225 and its daughters.

### Example 2—Evaluating Coupled HPLC-RadioTLC for Pre-Release Assessment of the Radiochemical Purity of ²²⁵Ac-Labeled Radiopharmaceuticals

### Methods

To carry out the radioTLC analysis, a new moving stage was designed to fit the Bioscan Mini-Scan TLC system. The moving stage was printed in the same dimensions as the original stage supplied by the manufacturer but could hold a custom-made 3D printed insert with the dimensions 205×27×7 mm comprising a total of 40 wells, each of which can hold a maximum volume of 100 μL. The moving stage was 3D printed using PLA. The prints of the inserts were obtained from ProtoLabs (USA) using both polypropylene and a 40% glass-filled nylon as materials for compatibility with the organic solvents used as HPLC mobile phases. A few grains of solidifier (Stericycle) were added to each well to decrease the risk of cross-contamination. The design of the insert is shown in FIG. 2.

Following HPLC analysis and fraction collection, a maximum volume of 100 μL per fraction were transferred to the insert. The wells containing the solidified fractions were then covered with a thin plastic and the insert placed in the newly designed moving stage. Plates were scanned on the Bioscan Mini-Scan TLC system using a Bioscan Flow Count detector.

### Summary of Results

The model compound for the analysis, [225Ac]Ac-RPS-063, is a small molecule radioligand targeting prostate specific membrane antigen (PSMA) and containing DOTA for chelating radiometals (Kelly et al., “A Single Dose of ²²⁵Ac-RPS-074 Induces a Complete Tumor Response in an LNCaP Xenograft Model,” Journal of Nuclear Medicine, 60 (5): 649-655 (2018), which is hereby incorporated by reference in its entirety). [²²⁵Ac]Ac-RPS-063 was synthesized at a molar activity of 0.05-0.055 MBq/nmol.

Key parameters for comparison that define the limitations of an analytical method for quantification of RCP include limit of detection (LOD), limit of quantification (LOQ), signal-to-noise (S/N), and resolution. These parameters depend on the properties of the specific instruments used for the analysis and are crucial to determine prior to quantitating RCP.

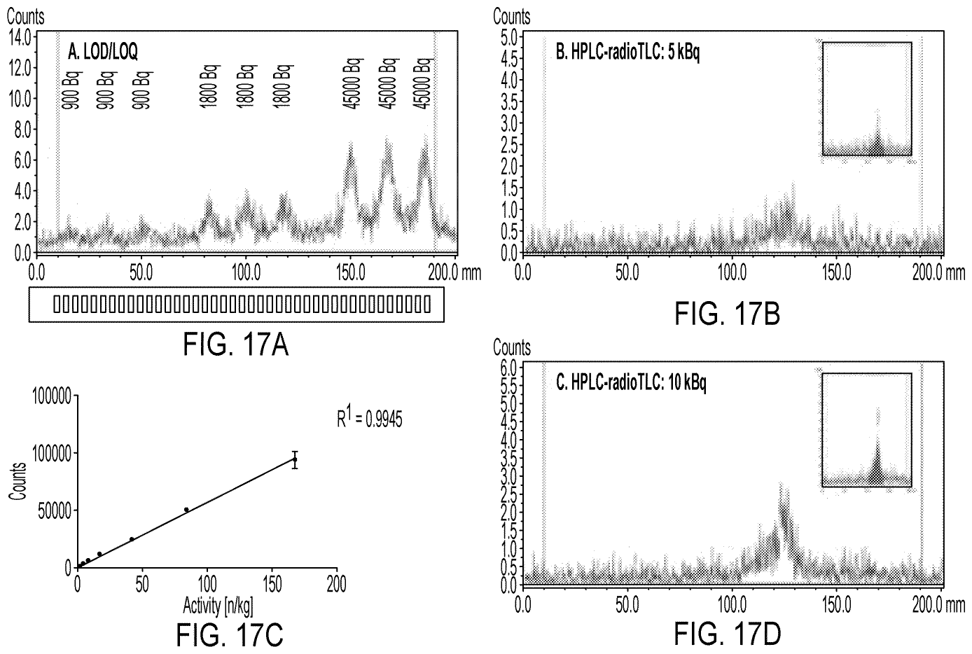

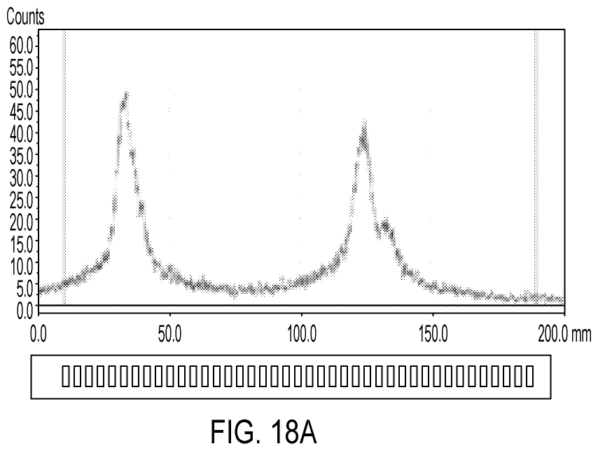

Using the 3D printed insert, calibration curves were derived for the radioTLC scanner at three different scan speeds (FIGS. 17A-17D). With the system described herein, the LOD and LOQ, which are in the range of 1000 Bq, are approximately 50-fold higher than gamma counting and approximately 500-fold higher than phosphor imaging. An injected activity of 10 kBq on the HPLC was sufficient to achieve S/N>10 when HPLC fractions were aliquoted into wells of the 3D printed insert. Lower injected activities were not tested to determine the minimum activity required.

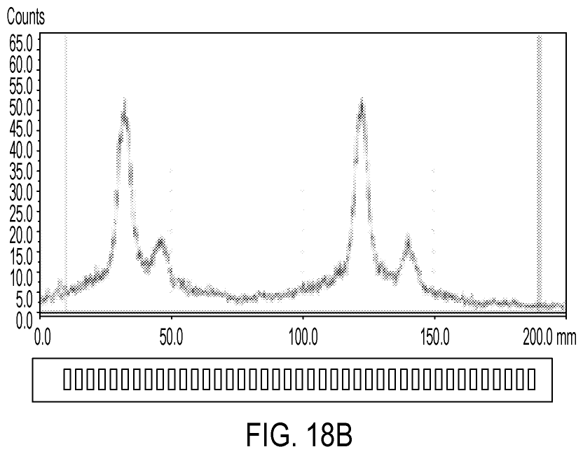

The ability of the 3D printed system to resolve peaks was tested by varying the number of empty wells between two aliquots of known activities and scanning speeds. When the signals were in close proximity (≤4 wells spacing, corresponding to 40 s difference in t_{R} on the HPLC), peak resolution exceeded 1 at a scanning rate of 0.125 mm/s (FIGS. 18A-18B). Resolution was comparable at faster scanning rates, but decreasing S/N ratios compromised the detection of the aliquot with lower activity. Therefore, it is expected that the requirement for slower scanning speed will become even more acute when lower activities are collected in the HPLC fractions.

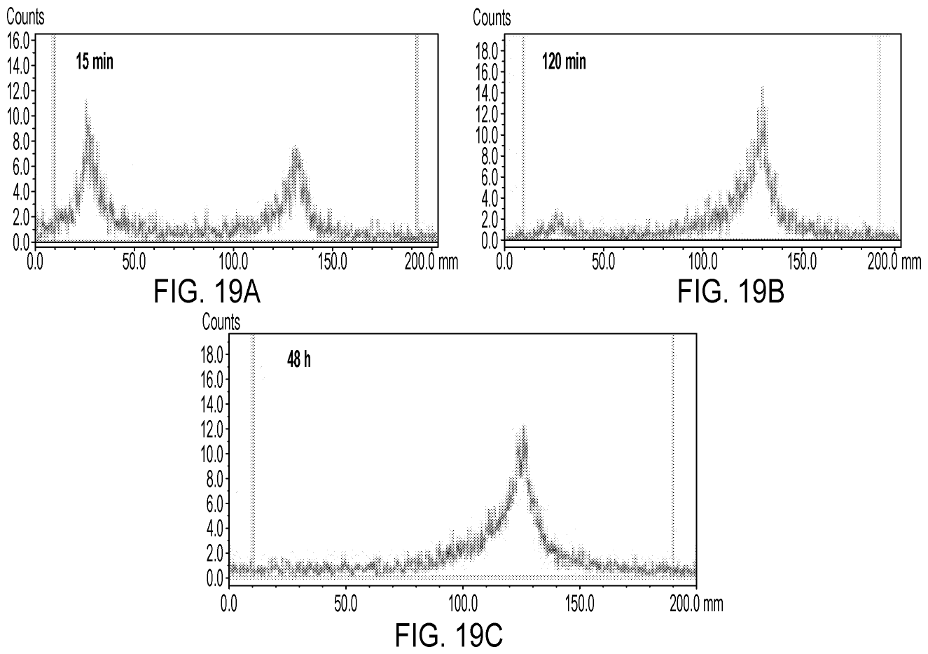

In agreement with pre-equilibrium measurements performed on the gamma counter and phosphor imager, serial scanning of the TLC insert beginning 15 min after fraction collected revealed that the apparent RCP of [²²⁵Ac]Ac-RPS-063 increased from 15 min to 48 h (FIGS. 19A-19C).

Finally, a pilot study was performed to establish the ability of the coupled HPLC-radioTLC method to quantify the amount of radiochemical impurity. In this experiment, the parent compound was mixed in a known ratio with a radiolabeled impurity. The total amount of uncomplexed radiometal was minimal. Fractions were collected at 5 sec intervals from the HPLC to enable the relevant section of the radiochromatogram to be reconstructed in 80 fractions. When the radiolabeled impurity was present in small amounts (≤10%), it was visible only at slow scanning speeds. These corresponded to slightly longer scanning times relative to faster scanning speeds, but significantly shorter analyses than gamma counting or phosphor imaging.

### Conclusions

HPLC coupled with radioTLC is comparatively rapid as an analytical method and TLC scanners are commonly available to most radiochemistry laboratories. The reconstruction of the chromatogram from fractions collected during an analytical HPLC run is possible and can begin at approximately 2 h after the end of the run, which is in the same time range as is currently being employed for RCP analysis by TLC alone (Kelly et al., “A suitable time point for quantifying the radiochemical purity of 225Ac-labeled radiopharmaceuticals,” Radiopharm. Chem. 6:38 (2021), which is hereby incorporated by reference in its entirety). The accurate quantification of an impurity depends on the injected activities and is in the range of 5-10 kBq with our Bioscan Mini-Scan system, corresponding to 10-20% impurity if a total activity of 50 kBq is injected. While other techniques like gamma counting to quantify the activity in the individual HPLC fractions are more sensitive and can detect much smaller amounts of impurities at lower injected activities, more sensitive gamma detectors for the TLCs scanners are already available on the market and will continue to be developed. Another limitation of the presented coupled HPLC-radioTLC method is its modest peak resolution. However, the customizable design of the inserts allows the analysis to be tailored to any individual radiopharmaceutical, thereby presenting opportunities to improve the resolution based on well spacing and HPLC chromatographic methods. Given the prevalence of HPLC and radioTLC systems routinely present in production laboratories, implementation of this method on commercially available systems for clinical production of 225Ac-labeled radiopharmaceuticals is straightforward. Most significantly, by reducing the analysis time compared to gamma counting or phosphor imaging, this method renders accurate RCP a feasible pre-release QC assay.

### Example 3—Evaluating Parameters for Pre-Release Assessment of the Radiochemical Purity of 225Ac-Labeled Radiopharmaceuticals

The continued clinical translation of targeted alpha therapy (TAT) with ²²⁵Ac-labeled radiopharmaceuticals requires the development of a method of quickly and accurately determining the radiochemical purity (RCP) of these compounds. The complex decay of ²²⁵Ac, whose daughters ²²¹Fr and ²¹³Bi are the principal gamma emitters, complicates this analysis because chromatographic separation necessarily disrupts radiochemical equilibrium between ²²⁵Ac and its daughters. The possibility of radiolabeled impurities or radiolytic products beyond uncomplexed radiometals renders high performance liquid chromatography (HPLC) an essential method for assessing RCP, but an accurate radiochromatogram can only be generated retrospectively after the activity in collected HPLC fractions is determined, typically by gamma counting, at equilibrium between ²²⁵Ac and ²²¹Fr. As such, this method is typically recommended for post-release confirmation of product purity. The aim here was to determine the advantages and drawbacks to coupling HPLC with gamma counting, phosphor imaging, and thin layer chromatography (TLC) scanning for pre-release assessment of RCP.

The successful translation of targeted radioligand therapeutics, such as [¹⁷⁷Lu]Lu-PSMA-617 (Pluvicto®) and [¹⁷⁷Lu]Lu-DOTATE (Lutathera®), highlights the growing importance of this approach to the treatment of patients with metastatic cancer. Despite significant improvements in overall and progression-free survival in many patients treated with these agents, 20-30% do not respond while others rapidly relapse (Ahmadzadehfar et al., “177Lu-PSMA-617 Radioligand Therapy of mCRPC: Evaluation Criteria of Response,” European Journal of Nuclear Medicine and Molecular Imaging 44(1): 166-167 (2016); Baum et al., “177Lu-Labeled Prostate-Specific Membrane Antigen Radioligand Therapy of Metastatic Castration-Resistant Prostate Cancer: Safety and Efficacy,” Journal of Nuclear Medicine 57 (7): 1006-1013 (2016), Emmett et al., “Results of a Prospective Phase 2 Pilot Trial of 177Lu-PSMA-617 Therapy for Metastatic Castration-resistant Prostate Cancer Including Imaging Predictors of Treatment Response,” Clinical Genitourinary Cancer 17 (1): 15-22 (2019), Hofman et al., “High Activity, Pain Reduction and Low Toxicity with Lutetium-177 PSMA617 Theranostics in Metastatic Castrate-Resistant Prostate Cancer (mCRPC): Results of a Phase II Prospective Trial,” The Journal of Nuclear Medicine 59:531 (2018), which are hereby incorporated by reference in their entirety). Targeted alpha therapy (TAT), in which alpha particle-emitting radionuclides are selectively delivered to tumors, is emerging as an effective strategy to improve response and prolong survival for patients with metastasized cancer (Kratochwil et al., “Targeted α-Therapy of Metastatic Castration-Resistant Prostate Cancer with 225Ac-PSMA-617: Swimmer-Plot Analysis Suggests Efficacy Regarding Duration of Tumor Control,” J. Nucl. Med. 59:795-802 (2018), Kratochwil et al., “Dosing 225Ac-DOTATOC in Patients with Somatostatin-Receptor-Positive Solid Tumors: 5-year Follow-up of Hematological and Renal Toxicity,” Eur. J. Nucl. Med. Mol. Imaging 49:54-63 (2021); Zacherl et al., “First Clinical Results for PSMA-Targeted α-Therapy Using 225Ac-PSMA-I&T in Advanced-mCRPC Patients,” J. Nucl. Med. 62:669-674 (2021); Delpassand et al., “Targeted α-Emitter Therapy with 212Pb-DOTAMTATE for the Treatment of Metastatic SSTR-Expressing Neuroendocrine Tumors: First-in-Humans Dose-Escalation Clinical Trial,” J. Nucl. Med. 63:1326-1333 (2022), which are hereby incorporated by reference in their entirety). The improved efficacy of TAT is attributed to the high linear energy transfer (LET) of alpha particles, which deposit large energies (80 keV/μm) over short distances (50-100 μm) (Poty et al., “α-Emitters for Radiotherapy: From Basic Radiochemistry to Clinical Studies—Part 1,” J. Nucl. Med. 59 (6): 878-884 (2018), which is hereby incorporated by reference in its entirety). High LET radiation is highly ionizing, leading to the formation of complex DNA double strand breaks, membrane peroxidation, and other cytotoxic stresses (Pouget and Mather, “General Aspects of the Cellular Response to Low- and High-LET Radiation,” Eur. J. Nucl. Med. 28 (4): 541-61 (2001); Pouget & Constanzo, “Revisiting the Radiobiology of Targeted Alpha Therapy,” Front. Med. (Lausanne) 8:692436 (2021); Targeted Alpha Therapy Working Group et al., “Targeted Alpha Therapy, an Emerging Class of Cancer Agents: A Review,” JAMA Oncol. 4 (12): 1765-1772 (2018); Poty et al., “α-Emitters for Radiotherapy: From Basic Radiochemistry to Clinical Studies—Part 1,” J. Nucl. Med. 59(6): 878-884 (2018), which are hereby incorporated by reference in their entirety). Actinium-225 is an attractive radionuclide for this application because it decays via 6 daughter nuclides to stable ²⁰⁹Bi (t_{1/2}=2.01×10¹⁹ years) by emission of 4 alpha and 2 beta particles. Although this complex decay chain is advantageous in the context of anti-tumor activity, it presents significant challenges to assessing the purity of the labeled compound prior to its administration to patients.

Safe administration of radiopharmaceuticals to human patients requires accurate assessment of their chemical and radiochemical purity prior to batch release. For small molecule radiopharmaceuticals, this analysis is typically performed by high performance liquid chromatography (HPLC) because this technique allows the chemical identity and radiochemical purity to be determined simultaneously by measuring UV absorbance and scintillation counts, respectively. However, these chromatograms are not suitable for determining radiochemical purity (RCP) for ²²⁵Ac-labeled radiopharmaceuticals because ²²⁵Ac (t_{1/2}=9.9 d) is not in secular equilibrium with its progeny nuclides—primarily ²²¹Fr (t_{1/2}=4.8 min) and ²¹³Bi (t_{1/2}=45.6 min), the primary emitters of gamma radiation detectable by most gamma detectors (Kelly et al., “A Suitable Time Point for Quantifying the Radiochemical Purity of 225Ac-Labeled Radiopharmaceuticals,” EJNMMI Radiopharm. Chem. 6:38 (2021), which is hereby incorporated by reference in its entirety). As a further complication, the decay of ²²⁵Ac to ²²¹Fr releases the latter from the chelating moiety due to a recoil energy >100 keV, many fold larger than bond dissociation energies (Kruijff et al., “The In Vivo Fate of ²²⁵Ac Daughter Nuclides Using Polymersomes as a Model Carrier,” Scientific Reports 9:11671 (2019), which is hereby incorporated by reference in its entirety). Thus, the chromatogram reflects the complex decay of ²²⁵Ac and comprises daughter nuclides (both released and bound) in addition to the ²²⁵Ac-labeled radiopharmaceutical and any potential ²²⁵Ac-labeled impurities formed during the synthesis. Although the energies of the emissions of ²²⁵Ac and its daughters are different, typical flow cell gamma detectors used for HPLC cannot distinguish between photons (or alpha or beta particles) of different energies and may even detect these emissions with different efficiencies. In addition, as chromatographic separation necessarily disrupts radiochemical equilibrium, even HPLC methods that fully separate all components of the product mixture cannot be used to quantify RCP because the relative peak integrals do not reflect the true proportion of species present in the analyte.

As a result, release of ²²⁵Ac-labeled radiopharmaceuticals for administration to patients has typically been based on assessment of radiochemical purity by radio-thin layer chromatography (radioTLC) (Feuerecker et al., “Activity and Adverse Events of Actinium-225-PSMA-617 in Advanced Metastatic Castration-resistant Prostate Cancer After Failure of Lutetium-177-PSMA,” European Urology 79 (3): 343-350 (2021); Kratochwil et al., “²²⁵Ac-PSMA-617 for PSMA-Targeted α-Radiation Therapy of Metastatic Castration-Resistant Prostate Cancer,” The Journal of Nuclear Medicine, 57 (12): 1941-1944 (2016), which are hereby incorporated by reference in their entirety). Although this method is suitable for estimating the RCP with respect to the amount of ²²⁵ Ac bound to the radiopharmaceutical as early as 2 h after the end of development (Kelly et al., “A Single Dose of 225Ac-RPS-074 Induces a Complete Tumor Response in an LNCaP Xenograft Model,” Journal of Nuclear Medicine 60(5): 649-655 (2018), which is hereby incorporated by reference in its entirety), it is less suited to separating other radiolabeled impurities from the desired compound. While representing an essential assay for pre-release quality control (QC), it may not be sufficient as a standalone technique to meet the requirements of regulatory agencies such as the FDA.

One solution to this problem is to retrospectively reconstruct the HPLC radiochromatogram by continuous fraction collecting during the analytical HPLC run and counting of the activity in these fractions using an automated gamma counter. If a sufficiently narrow counting window centered on the 218 keV photon emissions from ²²¹Fr is combined with corrections for back scattering from ²¹³Bi emissions, counting can begin 30 min after collection, at which point ²²⁵Ac and ²²¹Fr are approaching secular equilibrium (Abou et al., “Radiopharmaceutical Quality Control Considerations for Accelerator-Produced Actinium Therapies,” Cancer Biother. Radiopharm. 37:355-363 (2022); Hooijman et al., “Implementing Ac-225 Labelled Radiopharmaceuticals: Practical Considerations and (Pre-)clinical Perspectives,” EJNMMI Radiopharm. Chem. 9:9 (2024); Palluccio et al., “Macropa Beyond 225Ac: Chelation and Stability,” Journal of Nuclear Medicine 66:251363 (2025), which are hereby incorporated by reference in their entirety. When fractions are collected at a suitable sampling rate, the reconstructed chromatogram provides a more accurate assessment of radiochemical purity than is possible by TLC methods. However, depending on the number of fractions collected, gamma counting may not be completed for a couple of hours, and, consequently, this method is currently recommended as a post-release assessment. Another recent study demonstrated the possibility of determining RCP for [²²⁵Ac]Ac-PSMA-617 by a coupled HPLC-radioTLC approach (Ahn and Belanger, “Automated Radiolabeling and Handling of 177Lu- and 225Ac-PSMA-617 using a Robotic Pipettor,” J. Label Compd. Radiopharm. 67:111-115 (2024), which is hereby incorporated by reference in its entirety). HPLC fractions were transferred by robot to 5 TLC plates scanned for 10-30 min per plate at secular equilibrium. The RCP calculated by this method was comparable to the RCP obtained from gamma counting.

To improve the QC of ²²⁵Ac-labeled radiopharmaceuticals for preclinical experiments, it was sought to define the advantages and drawbacks of HPLC coupled to gamma counting, phosphor imaging, and radioTLC as methods for performing pre-release quality control (QC) for ²²⁵Ac-labeled radiopharmaceuticals. This evaluation focused on the limits of detection (LOD) and quantification (LOQ), analysis time, and peak resolution, as major variables affecting the assessment of RCP and the quantification of radiolabeled impurities. Furthermore, to improve the sensitivity of this coupled HPLC-radioTLC approach, a custom-made moving stage and proof-of-concept 40-well insert were developed. This insert accommodated larger aliquots of HPLC fractions and increased the reproducibility and reduced the analysis time for radioTLC as a method of assessing the RCP of ²²⁵Ac-labeled compounds.

### Methods

### General

RPS-063 was prepared according to previously published procedures (Kelly et al., “A Single Dose of 225Ac-RPS-074 Induces a Complete Tumor Response in an LNCaP Xenograft Model,” Journal of Nuclear Medicine, 60 (5): 649-655 (2018), which is hereby incorporated by reference in its entirety). PTI-105 was provided as a gift by Ratio Therapeutics. Stock solutions were prepared in DMSO (Millipore Sigma, USA) at a concentration of 10 mg/mL. Buffers and reagents used in the radiosyntheses were trace metal grade and prepared using Milli-Q® Ultrapure 18.2 MΩ·cm H₂O (Millipore Sigma, USA). The dilute 0.2 M HCl was prepared from 37% wt/wt hydrochloric acid in H₂O (99.999% metals basis, Millipore Sigma, USA). 0.1 M NaOAc (ThermoFisher, USA; 99.997% metals basis) diluted to a concentration of 0.1 M in H₂O was used as the buffer in all radiosyntheses. The 20× formulation buffer comprised (+)-sodium L-ascorbate (Millipore Sigma, USA) and DTPA (Millipore Sigma, USA) at a concentration of 1.5 M and 0.5 mg/mL, respectively, in normal saline (0.9% NaCl, Hospira, USA). Buffers, solvents and reagents used to prepare mobile phases for TLC and HPLC analysis were purchased from Spectrum Chemicals, USA (sodium citrate), Millipore Sigma, USA (acetic acid, acetonitrile, citric acid, sodium hydroxide), VWR, USA (trifluoroacetic acid), and other sources for ammonium acetate and ammonium formate.

### Radiosynthesis

[²²⁵Ac]Ac(NO₃)₃ was provided by Oak Ridge National Laboratories under the Department of Energy Isotope Program. Activities were measured using a CRC-12R dose calibrator (Capintec, USA) using setting 775 multiplied by 5. The dried salt was dissolved in 100 μL 0.2 M HCl to an approximate activity concentration of 370 MBq/mL. An aliquot containing 400-1500 kBq was transferred to an Eppendorf™ Protein LoBind Tube (Millipore Sigma, USA). Next, 7-30 nmol RPS-063 (1.3-4.8 μL) or PTI-105 (1.1-4.5 μL) was added to the reaction vessel to achieve a molar activity between 0.5 MBq/nmol and 0.55 MBq/nmol. The pH was adjusted to 6 by addition of 0.1 M NaOAc. The total reaction volume was typically 70-80 μL and never exceeded 100 μL. The reaction was heated to 94 °C for 30 min and shaken at 700 rpm on an Eppendorf™ ThermoMixer® C heating block (Fisher Scientific, USA). The crude product was taken up in 13 mL H₂O and passed through a pre-conditioned Sep-Pak C18 light cartridge (Waters, USA). The cartridge was washed with 5 mL H₂O and dried with air. The product was eluted with 200 μL ethanol, 200 proof (Koptec, VWR, USA) followed by 750 μL normal saline. The eluate was diluted with 50 μL of 20× formulation buffer. The activity concentration of the final product was in the range of 300-1000 kBq/mL.

The RCP with respect to the amount of uncomplexed radiometal was determined by radioTLC. Two 1-2 μL aliquots of the formulated reaction product were spotted on separate alumina-backed silica gel 60 TLC plates (Millipore Sigma, USA). One plate was developed in 50 mM citrate, pH 5 and the second plate was developed in 50% v/v DMF (Millipore Sigma, USA) in 1 M NH₄OAc, pH 5.5. The plates were scanned on a Bioscan Mini-Scan TLC scanner (Eckert & Ziegler, USA) coupled to a Bioscan Flow-Count detector (Eckert & Ziegler, USA) a minimum of 2 h after they were developed.

### Analytical HPLC

Analytical HPLC was performed using a dual pump Agilent 1260 Infinity II system (Agilent Technologies, USA) equipped with a 1260 Infinity II variable wavelength detector (Agilent Technologies, USA) and an LB 500 HERM NaI radioactivity monitor (Berthold Technologies, USA) by injection of the analyte on a Symmetry C18, 100 Å, 5 μm, 4.6 mm×50 mm column (Waters, USA). Unless otherwise indicated, 10 mM ammonium formate (A) and acetonitrile (B) were used as the mobile phases. Gradients and intervals for fraction collection were tailored to each experiment and are reported in subsequent sections. UV absorption was measured at 220 nm and 254 nm. The flow rate was kept constant at 2 mL/min. The radiochemical purity at the end of synthesis and end of experiment (defined as the timepoint at which the final aliquot was removed for analysis) was confirmed by HPLC using the method described for the limits of detection and quantification determinations.

### Gamma Counting

Fractions collected from the HPLC were counted using a Wizard2 2470 Automatic Gamma Counter (Perkin Elmer, USA) at equilibrium >24 h after end of collection (unless otherwise indicated). Counting was performed using three windows: 180-240 keV (for detection of the gamma emission from ²²¹Fr), 350-450 keV (for detection of the gamma emission from ²¹³Bi), and 15-2000 keV (open window counting). Each sample was counted for 60 s.

### Phosphor Imaging

1 μL Aliquots of the collected HPLC fractions were transferred to a 10×10 cm alumina-backed silica gel 60 TLC plate (Millipore Sigma, USA). A grid of 400 individual squares (0.5×0.5 cm) had been outlined on the plate prior to the spotting of the fractions. The orientation of the plate was marked with a dilute Ac-225 sample on a minimum of 2 opposing sides. The plates were exposed on a MultiSensitive phosphor screen for either 2 min or 10 min and imaged using a Cyclone® Plus Storage Phosphor System (Perkin Elmer, USA) at 300 dpi. The signal was quantified as digital light units (DLU) per cm² by drawing a 20×20 circular grid over the image using the OptiQuant software. The design of the TLC plate is depicted in FIGS. 1-2.

### Radio TLC

To carry out the radioTLC analysis, a new moving stage was designed to fit the Bioscan Mini-Scan TLC system. The new stage had the same dimensions as the original stage but could hold a custom-made 3D printed insert with the dimensions 205×27×7 mm comprising a total of 40 wells, each of which can hold a maximum volume of 100 μL. The drawings for both the moving stage and the disposable inserts were made with AutoCAD Mechanical. The moving stage was printed on in ABS plastic. The inserts were printed by ProtoLabs (USA) in polypropylene and nylon. A few grains of liquid solidifier were added to each well for easier handling of the inserts and to decrease the risk of contamination by spilling. The design of the insert is shown in FIG. 2. Following HPLC analysis and fraction collection, a maximum volume of 100 μL per fraction were transferred to the insert. The wells containing the solidified fractions were then covered with a thin plastic and the insert placed in the newly designed moving stage. Plates were scanned on the Bioscan Mini-Scan TLC system using a Bioscan Flow Count detector at equilibrium >24 h after the end of fraction collection (unless otherwise specified). The insert was scanned at three different rates-0.125 mm/s, 0.25 mm/s and 0.5 mm/s.

### Determination of the Limit of Detection and Limit of Quantification

### Gamma Counter

To determine the limit of detection (LOD) and limit of quantification (LOQ) of the gamma counter, stock solutions of 1 kBq/μL, 20 Bq/μL, and 0.2 Bq/μL of an Ac-225 source were prepared in 1 mM DTPA. The stock solutions were serially diluted to produce the samples for analysis in triplicates in a total volume of 500 μL. The activity concentrations in the samples were 100 kBq, 50 kBq, 20 kBq, 10 kBq, 5 kBq, 2 kBq, 1 kBq, 0.5 kBq, 0.2 kBq, 0.1 kBq, 0.05 kBq, 0.02 kBq, 0.01 kBq, 0.005 kBq, 0.002 kBq, and 0.001 kBq, respectively. Seven blanks were included in each measurement. All samples were counted on a Wizard2 2470 Automatic Gamma Counter at full equilibrium >24 h after the transfer of the activities to the gamma counter tubes. The samples were initially counted using an energy window of 180-240 keV, with each sample counted for 60 s. Counts per minute (cpm) were corrected for decay to the start of the measurement, but not corrected for background activity, and a calibration curve was plotted using GraphPad Prism (San Diego, USA). Subsequently, the samples were counted again using an energy window of 350-450 keV and a third time using an open window protocol normalized to Ac-225 (15-2000 keV). The experiment was performed in triplicate. Linear regression analysis was performed using all data points. The LOD was calculated as LOD=3.3×σ/S, the LOQ was calculated as LOQ=10×σ/S, where S is the slope of the calibration curve. Values for σ were obtained either as the standard deviation of the blanks (data set 1) or as the standard deviation of the residuals (Sy.x) at low Ac-225 concentrations (data set 2). The Sy.x value of the linear regression of the lowest eight concentrations, 0.2 kBq, 0.1 kBq, 0.05 kBq, 0.02 kBq, 0.01 kBq, 0.005 kBq, 0.002 kBq, and 0.001 kBq, for which the highest y-value was just above ten times the background, was used for all three energy windows.

### Phosphor Imager

In analogy to the LOD and LOQ analysis for the gamma counter, serial dilutions containing activity concentrations ranging from 0.01 kBq/100 μL to 50 kBq/100 μL were prepared. 1 μL aliquots were spotted in pre-marked grids on an alumina-backed silica gel 60 TLC plate as described above. The total transferred activity corresponded to 200 Bq, 100 Bq, 50 Bq, 20 Bq, 10 Bq, 5 Bq, 2 Bq, 1 Bq, 0.5 Bq, 0.2 Bq, and 0.1 Bq, respectively. When full equilibrium was reached >24 h after the transfer of the activity, a MultiSensitive storage phosphor screen (Perkin Elmer, USA) was exposed to the marked TLC plate for a total exposure time of either 2 min or 10 min. The experiment was performed in triplicate. The phosphor screen was scanned on a Cyclone® Plus Storage Phosphor system (Perkin Elmer, USA) at 300 dpi. A calibration curve was drawn from the digital light units (DLU) obtained for the individual and LOD and LOQ values calculated as described for the gamma counter, with one exception. As the signal is strongly dependent on the exposure time, the activities included in the calculation of Sy.x were different at the 2 min and at 10 min exposure times. For the shorter exposure time, the eight lowest concentrations—20 Bq, 10 Bq, 5 Bq, 2 Bq, 1 Bq, 0.5 Bq, 0.2 Bq, and 0.1 Bq—were included, which corresponded to y-values of up to ten times the background. For the longer exposure time, only concentrations up to 5 Bq per spotted 1 μL were used to reach the ten times background limit.

### RadioTLC

To determine the LOD and LOQ of the radioTLC scanner, the newly designed insert and moving stage were used. Stock solutions of 6 kBq/μL and 20 Bq/μL of an ²²⁵Ac-source in 1 mM DTPA were prepared. These stock solutions were serially diluted to produce the samples for analysis and 50 μL aliquots were transferred in triplicate to each well of the insert. Each aliquot was separated by a minimum of 3 empty wells. The activities per well were 200 kBq (duplicates only), 100 kBq, 50 kBq, 20 kBq, 5 kBq, 2 kBq, 1 kBq, 0.5 kBq, and 0.2 kBq. The filled insert was scanned successively at 0.125 mm/s, 0.25 mm/s, and 0.5 mm/s. Each peak corresponding to one activity concentration was integrated manually by drawing a region-of-interest (ROI) across the peak diameter. The LOD and LOQ were determined from the calibration curve as described for the phosphor imager and the gamma counter.

### HPLC

For the sake of completeness, the limits of detection quantification were also determined for the HPLC as a stand-alone analysis method. However, the results can only be interpreted with great constraint and following a more in-depth discussion as to which emissions caused the residual signal. The values are therefore reported in brackets only and will be discussion in a later section of the manuscript.

[²²⁵Ac]Ac-RPS-063 was prepared as described above. The chromatograms used were obtained in the course of the LOD and LOQ determinations for the coupled HPLC-gamma counter and HPLC-phosphor imager analyses, which are described below. All chromatograms were manually integrated using the ChemStation software (Agilent Technologies, USA). The area of the peak corresponding to [²²⁵Ac]Ac-RPS-063 was plotted against the activity injected using GraphPad Prism (GraphPad Software, USA). The experiment was performed in triplicate. LOD and LOQ values were calculated as described above, but using only the Sy.x values including values up to the 20 kBq injection.

### HPLC-Gamma Counting

Aliquots containing 0.1 kBq, 0.2 kBq, 0.5 kBq, 1 kBq, 2 kBq, 5 kBq, 10 kBq, 20 kBq, 50 kBq or 100 kBq were injected on the HPLC, the maximum injected volume did not exceed 300 μL (500 μL sample loop).

### Determination of Signal-to-Noise Ratios

[²²⁵Ac]Ac-RPS-063 was synthesized at 0.02 MBq/nmol and purified by solid phase extraction as described above. The reaction product was diluted to a concentration of 500-600 kBq/mL. The final formulation contained 75 mM sodium ascorbate and 0.01 mg/mL DTPA.

To evaluate the signal-to-noise (S/N) ratio for the HPLC, gamma counter, and phosphor imager, aliquots containing 100 Bq to 100 kBq were injected onto the analytical HPLC column and fractions collected as previously described. Experiments were performed in triplicate. The fractions were counted on a Wizard2 2470 Automatic Gamma Counter >24 h after collection using a 180-240 keV energy window or a 350-450 keV energy window. The S/N ratio was determined by comparing the peak height of the peak corresponding to [²²⁵Ac]Ac-RPS-063 (H) to the height of the highest activity fraction collected in a representative background region (between a retention time of 4.5 to 7.0 min; h) and using the formula: S/N=2H/h.

To determine the S/N ratio of the phosphor imager, 1 μL aliquots were transferred from the HPLC fractions to a preprepared alumina-backed silica gel 60 TLC plate (Millipore Sigma, USA). The TLC plate was exposed on a phosphor screen for 2 min, 5 min, or 10 min. The phosphor screen was imaged using a Cyclone® Plus Storage Phosphor system. The S/N ratio was determined as described above.

To determine the S/N ratio for radioTLC, 5 kBq, 10 kBq, 20 kBq, 50 kBq, or 100 kBq [²²⁵Ac]Ac-RPS-063 was injected on the HPLC. Experiments were performed in triplicate. Fractions were collected in 10 s intervals from 0-7 min and in 30 s intervals from 7-10 min. Forty aliquots of 50 μL, representing retention time 2.5 to 7.5 min, were transferred to consecutive wells in the 3D printed insert. The insert was scanned at 0.125 mm/s, 0.25 mm/s, and 0.5 mm/s on a Bioscan Mini-Scan TLC scanner coupled with a Bioscan Flow-Count detector. An ROI corresponding to [²²⁵Ac]Ac-RPS-063 and an ROI corresponding to background signal (5 min≤t_{R}≤7 min) were selected and the maximum height of each ROI was recorded. The S/N ratio was determined as described above.

### Determination of the Time-Dependence of Analysis

[²²⁵Ac]Ac-RPS-063 was synthesized as described. The compounds were injected sequentially onto the analytical HPLC column and fractions were collected in 5 s intervals from 0-7 min and in 30 s intervals from 7-10 min. Aliquots of the collected fractions were spotted onto a TLC plate for phosphor imaging or the 3D printed insert for radioTLC scanning. The entire fraction was counted on the gamma counter. Gamma counting was performed using the 180-240 keV energy window at 15 min, 30 min, 60 min, or 24 h after fraction collection. Phosphor imaging and radioTLC scanning were performed at 30 min, 45 min, 60 min, 90 min, 120 min, or 24 h after fraction collection.

### Determination of Peak Resolution

[²²⁵Ac]Ac-RPS-063 and [²²⁵Ac]Ac-PTI-105 were synthesized as described above. The activities of each solution were determined at secular equilibrium, and 50 kBq aliquots of [²²⁵Ac]Ac-RPS-063 were transferred to LoBind Eppendorf tubes. The aliquots were spiked with 10% activity basis (5 kBq) [²²⁵Ac]Ac-PTI-105 and injected onto the analytical HPLC column. Fractions were collected in 2 s, 5 s, 10 s, 20 s, or 30 s intervals from 0-7 min post injection and in 30 s intervals from 7-10 min post injection. The fractions were counted by gamma counting using the 180-240 keV energy window and the 350-450 keV energy window. The radiochromatograms were reconstructed as described above and resolution between the peaks corresponding to [²²⁵Ac]Ac-RPS-063 and [²²⁵Ac]Ac-PTI-105 were calculated using the drop method by the following equation: resolution=2×(t_{R}⁰⁶³−t_{R}¹⁰⁵)/(W⁰⁶³+W¹⁰⁵), where t_{R}⁰⁶³ and t_{R}¹⁰⁵ are the retention times—as defined by the maximum peak height—of [²²⁵Ac]Ac-RPS-063 and [²²⁵Ac]Ac-PTI-105, respectively, and W⁰⁶³ and W¹⁰⁵ are the widths of the peaks.

### Quantification of a Radiolabeled Impurity

[²²⁵Ac]Ac-RPS-063 and [²²⁵Ac]Ac-PTI-105 were synthesized as described above. The activities of each solution were determined at secular equilibrium, and 50 kBq aliquots of [²²⁵Ac]Ac-RPS-063 were transferred to LoBind Eppendorf tubes. The aliquots were spiked with 1% activity basis (0.5 kBq) to 50% activity basis (25 kBq) [²²⁵Ac]Ac-PTI-105 and injected onto the analytical HPLC column. Fractions were collected as previously described and the radiochromatogram was reconstructed after gamma counting, phosphor imaging, or radioTLC scanning. The relative areas under the curve of the peaks corresponding to [²²⁵Ac]Ac-RPS-063 and [²²⁵Ac]Ac-PTI-105 were compared to the known ratio of products in the analyte.

### Results

### Coupled HPLC-Gamma Counting and HPLC-Phosphor Imaging

The model compound for the analysis, [²²⁵Ac]Ac-RPS-063, is a small molecule radioligand targeting prostate specific membrane antigen (PSMA) and containing DOTA for chelating radiometals (Kelly et al., “A Single Dose of ²²⁵Ac-RPS-074 Induces a Complete Tumor Response in an LNCaP Xenograft Model,” Journal of Nuclear Medicine 60 (5): 649-655 (2018), which is hereby incorporated by reference in its entirety). [²²⁵Ac]Ac-RPS-063 was synthesized at a molar activity of 0.05-0.055 MBq/nmol, and only syntheses with an RCP>95%, as assessed by radioTLC coupled with phosphor imaging, were used. Surprisingly, significant decomplexation or streaking of [²²⁵Ac]Ac-RPS-063 was observed when using H₂O/MeCN containing 0.05% trifluoroacetic acid as the mobile phase. This effect was found to be suppressed when the less acidic 10 mM ammonium formate was used as the mobile phase.

Although there are currently no ²²⁵Ac-labeled radiopharmaceuticals approved for clinical use, radiopharmaceutical quality will almost certainly be required to match the release criteria established for approved ¹⁷⁷Lu-labeled compounds such as Pluvicto®. As such, radiochemical purity should exceed 95% and the analytical method to determine RCP must be able to detect as little as 1% of any possible radiochemical impurity. Parameters like the limit of detection (LOD), limit of quantification (LOQ), signal-to-noise (S/N), and resolution depend on the properties of the specific instruments used for the analysis and are crucial to determine prior to quantitating RCP.

TABLE 1
LOD and LOQ Values

| | LIMIT OF DETECTION (LOD) | | | | LIMIT OF QUANTIFICATION (LOQ) | | | |
|---|---|---|---|---|---|---|---|---|
| | A_{LOD} = (3.3 · σ)/S | | A_{LOD} = (3.3 · σ)/S | | A_{LOD} = (3.3 · σ)/S | | A_{LOD} = (3.3 · σ)/S | |
| | σ = SD_{Blank} | | σ = Sy.x | | σ = SD_{Blank} | | σ = Sy.x | |
| Gamma Counter | | | | | | | | |
| ²²¹Fr (180-240 keV) | 9.1 ± 3.9 | Bq | 13.0 ± 3.0 | Bq | 27.4 ± 11.7 | Bq | 39.4 ± 9.2 | Bq |
| ²¹³Bi (350-450 keV) | 20.3 ± 7.9 | Bq | 21.3 ± 3.0 | Bq | 61.6 ± 24.0 | Bq | 64.4 ± 9.1 | Bq |
| Open Window | 22.6 ± 5.0 | Bq | 13.2 ± 2.7 | Bq | 68.5 ±15.3 | Bq | 40.1 ± 8.3 | Bq |
| Phosphor Imager | | | | | | | | |
| 2 min exposure | 0.4 ± 0.2 | Bq | 2.0 ± 0.8 | Bq | 1.1 ± 0.5 | Bq | 6.0 ± 2.5 | Bq |
| 10 min exposure | 0.1 ± 0.02 | Bq | 0.5 ± 0.1 | Bq | 0.3 ± 0.05 | Bq | 1.4 ± 0.4 | Bq |
| [HPLC] | | | | | | | | |
| [LB 500 HERM Nal | | | [3.8 ± 1.9 | kBq] | | | [11.5 ± 5.7 | kBq] |
| Gamma Detector] | | | | | | | | |
| HPLC-Gamma Counter | | | | | | | | |
| ²²¹Fr (180-240 keV) | | | 0.07 ± 0.06 | kBq | | | 0.21 ± 0.18 | kBq |
| ²¹³Bi (350-450 keV) | | | 0.09 | kBq | | | 0.28 | kBq |
| HPLC-Phosphor Imager | | | | | | | | |
| 2 min exposure | | | | | | | | |
| 10 min exposure | | | | | | | | |

To determine the LOD and LOQ for the analytical systems, calibration curves measuring the response to serially diluted activities of an Ac-225 source were plotted (decay corrected to the start of the counting/exposure of the phosphor screen). As the measurement uncertainty, σ, can be obtained either from the calibration curve as the deviation of the points from the line (Sy.x) or from the standard deviation of repeated blank measurements, LODs and LOQs were determined using both σ values (Table 1). For the gamma counting, three different energy windows were used in this study, 180-240 keV targeting the gamma emission from ²²¹Fr (E_{γ}=218 keV), 350-450 keV corresponding to the gamma emission of ²¹³Bi (E_{γ}=440 keV), and an open window count normalized to Ac-225 (15-2047 keV). The LODs and LOQs determined by both methods and for all three energy windows were in a similar range, with only minor differences caused by higher or lower variabilities in the blank measurements and the lower total number of counts in the ²¹³Bi energy window. For the 180-240 keV energy window, the LOD was 9.1±3.9 Bq (o determined from the standard deviation of the blanks) and 13.0±3.0 Bq (o derived from the calibration curve as Sy.x), respectively with LOQs of 27.4±11.7 Bq and 39.4±9.2 Bq. In the second narrow energy window of 350-450 keV, the LOD was 20.3±7.9 Bq or 21.3±3.0 Bq and the LOQ was 61.6±24.0 Bq or 64.4±9.1 Bq. In the open window protocol, LODs of 22.6±5.0 Bq and 13.2±2.7 Bq were found, which corresponded to LOQs of 68.5±15.3 Bq and 40.1±8.3 Bq, respectively. All measurements were carried out at full equilibrium of Ac-225 with all daughter nuclides in the decay chain.

The limits of detection and quantification for the phosphor imager are highly dependent on the exposure time of the phosphor screen with longer exposure times corresponding to lower LOD and LOQ values. The parameters exemplary for a short 2 min and a 10 min exposure time were therefore determined. The limit of detection was found to be 0.4±0.2 Bq and 2.0±0.8 Bq, respectively, for the 2 min exposure and 0.1±0.02 Bq and 0.5±0.1 Bq for the 10 min exposure. For the shorter exposure time the limit of quantification was 1.1±0.5 Bq or 6.0±2.5 Bq. LOQs of 0.3±0.05 Bq and 1.4±0.4 Bq, respectively, were found for the 10 min exposure.

Even though the true amount of uncomplexed metal cannot be accurately determined by radioHPLC, peaks corresponding to the labeled product, [²²⁵Ac]Ac-RPS-063, and known ²²⁵Ac-labeled impurities introduced to the product mixture, are evident in the chromatogram generated by the system described herein. Using the product peak as a reference, the limit of detection for the HPLC set up described herein was 3.8±1.9 kBq and the limit of quantification was 11.5±5.7 kBq.

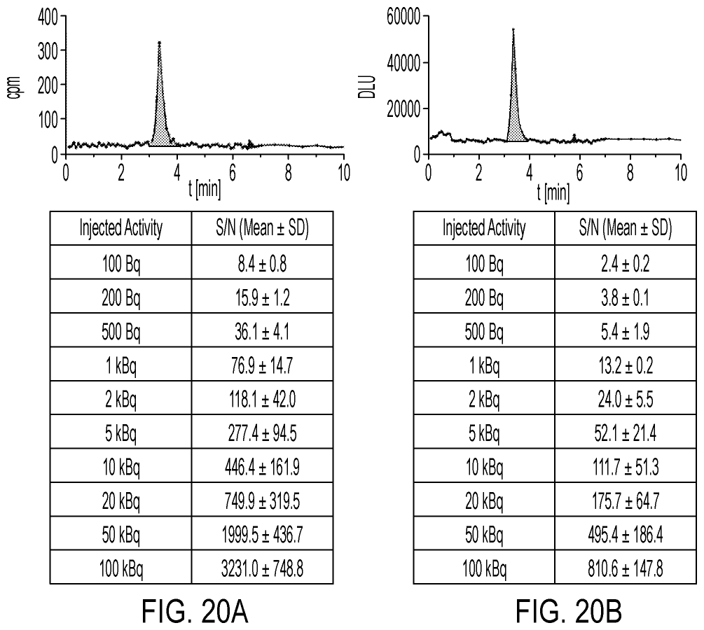

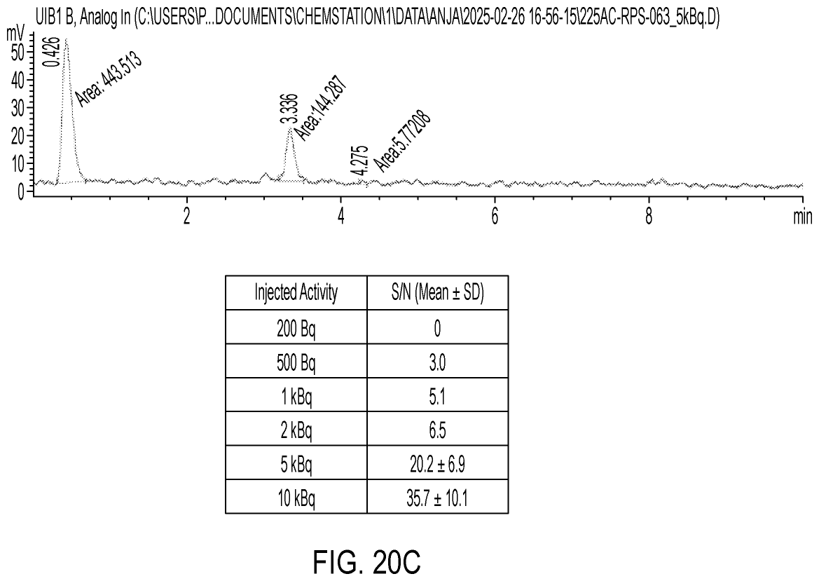

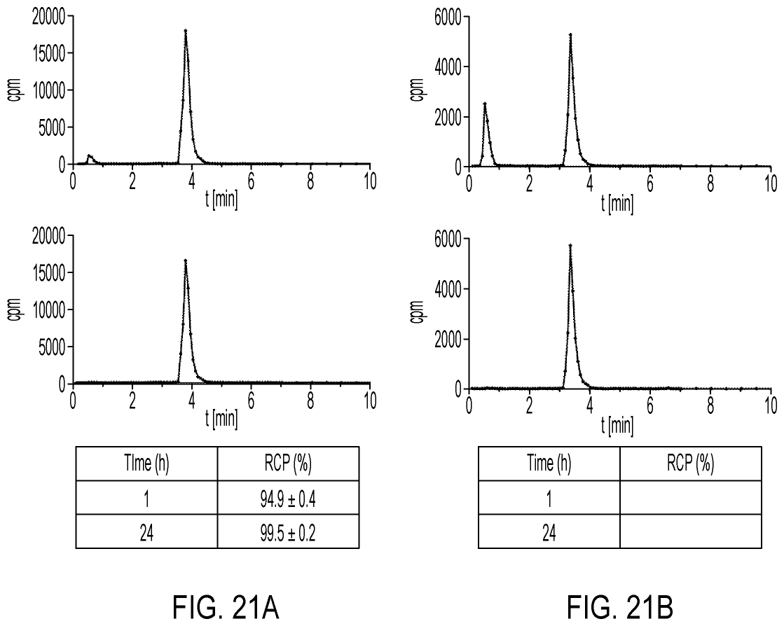

These studies were followed up by determining the signal-to-noise (S/N) ratios in the HPLC radiochromatograms and reconstructed radiochromatograms generated by coupled HPLC-gamma counting and HPLC-phosphor imaging as a function of the injected activity. This study was designed to determine how the LOD and LOQ relate to the amount of material required for QC given the radiolabeling yield and the total recovery of activity from the HPLC. For these experiments, 100 Bq-100 kBq [²²⁵Ac]Ac-RPS-063 was injected and 90 fractions were collected over a 10 min run. The lowest injected activity for which S/N>10 was reproducibly achieved was 5 kBq for the HPLC, 200 Bq for the gamma counter, and 1 kBq for the phosphor imager (FIGS. 20A-20C). The highest S/N ratios for the phosphor imager were obtained with a 10 min exposure time, while there was no appreciable difference between the S/N ratios for the gamma counter when 180-240 keV or 350-450 keV energy windows were used. With a view towards defining the earliest timeline possible for analysis, the HPLC fractions were counted on the gamma counter 15 min, 30 min, or 60 min after collection. A final count was performed after ²²⁵Ac was in secular equilibrium with all of its daughters (>24 h). Despite counting with a restricted energy window of 180-240 keV designed to detect only the gammas emitted by ²²¹Fr, counting initiated 60 min after fraction collection, which occurs even after secular equilibrium between ²²⁵Ac and ²²¹Fr is established after approximately 30 min, did not fully agree with the chromatogram obtained at full secular equilibrium (FIGS. 21A-21B). Early measurement underestimated RCP by approximately 5% (94.9±0.4% vs. 99.5±0.2% at full equilibrium). The difference was slightly larger when counting was performed in the 350-450 keV energy window targeting the emissions of ²¹³Bi. Prior work by our group established the need to wait 90 min after TLC development to accurately determine RCP by phosphor imaging (Kelly et al., “A Single Dose of ²²⁵Ac-RPS-074 Induces a Complete Tumor Response in an LNCaP Xenograft Model,” Journal of Nuclear Medicine 60 (5): 649-655 (2018), which is hereby incorporated by reference in its entirety).

Given the 10 min analytical HPLC method described herein, fractions were collected at 5 s intervals from 0-7 min of the run, when the product and related impurities were expected to elute. To investigate the feasibility of reducing sampling time to accelerate fraction counting and/or phosphor imaging, the effect of sampling time on peak resolution was tested for a mixture comprising [225Ac]Ac-PTI-105 (10% by activity) and [²²⁵Ac]Ac-RPS-063. These compounds are structurally similar and PTI-105 represents a plausible radiolysis product whose retention time is similar to RPS-063. [²²⁵Ac]Ac-RPS-063 eluted with a retention time, t_{R}, of 3.8 min while [²²⁵Ac]Ac-PTI-105 eluted with t_{R}=3.3 min. Shorter sampling times led to improved peak resolution using the gamma counter. When the radiochromatograms were reconstructed following gamma counting in the 180-240 keV energy window, the resolution between [²²⁵Ac]Ac-PTI-105 and [²²⁵Ac]Ac-RPS-063 was 0.5 with 2 s and 5 s sampling and 0.4 with 10 s sampling. Sampling with 20 s and 30 s intervals failed to resolve the peaks at all. Counting in the 350-450 keV window resulted in slightly higher resolution, which was measured to be 0.6 with 2 s and 5 s sampling and 0.5 with 10 s sampling. Once again, 20 s and 30 s sampling intervals failed to resolve the peaks. By comparison, the peak resolution of [²²⁵Ac]Ac-PTI-105 and [²²⁵Ac]Ac-RPS-063 was 2.6±0.2 in the HPLC radiochromatogram irrespective of the relative amounts of [²²⁵Ac]Ac-PTI-105 and [²²⁵Ac]Ac-RPS-063 injected. The peak resolution in the reconstructed radiochromatogram obtained from the phosphor imager was 0.66 for a 2 min exposure time, which decreased to 0.52 for a 10 min exposure time. The difference is likely due to spillover of activity into adjacent ROIs on the grid at higher activities (and longer exposure times). However, this experiment was only performed as a single replicate.

These studies provided a basis for a pilot study to investigate the ability of the HPLC, the coupled HPLC-gamma counting and the coupled HPLC-phosphor imaging methods to quantify a simulated radiolabeled impurity. Increasing amounts were mixed, from 0.5-25 kBq (1-50% by activity), of [²²⁵Ac]Ac-PTI-105 with 50 kBq [²²⁵Ac]Ac-RPS-063. As sequential injections of the reaction products were required to generate the different mixtures, it was first verified that the reaction products, [225Ac]Ac-RPS-063 and [²²⁵Ac]Ac-PTI-105, were stable under the storage conditions for at least 24 h.

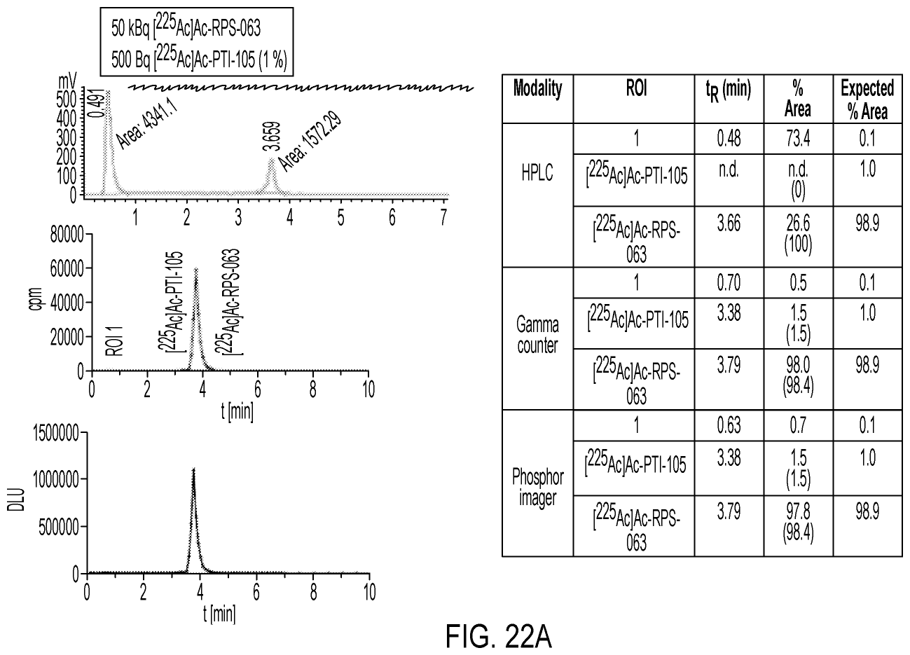

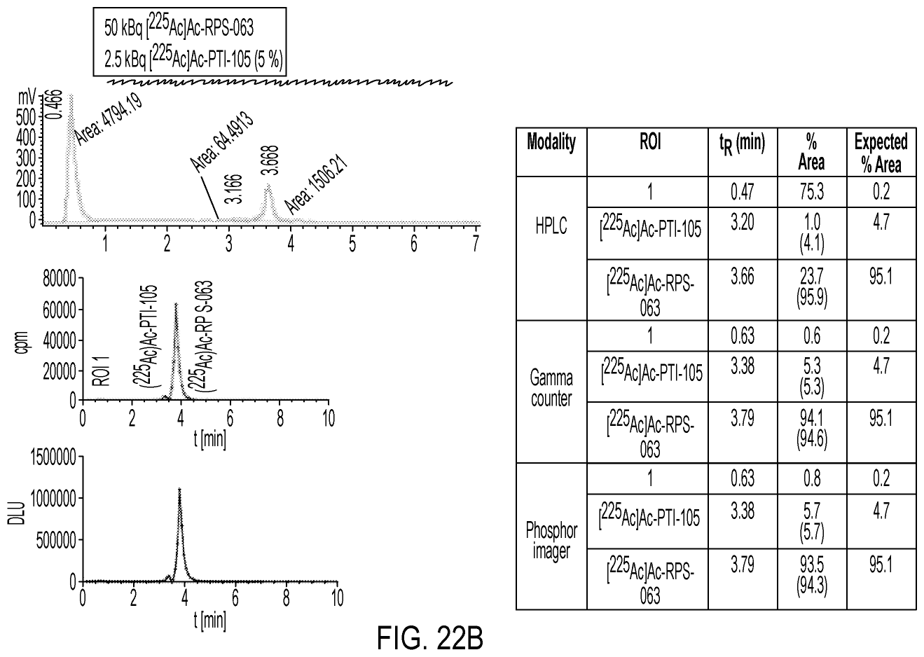

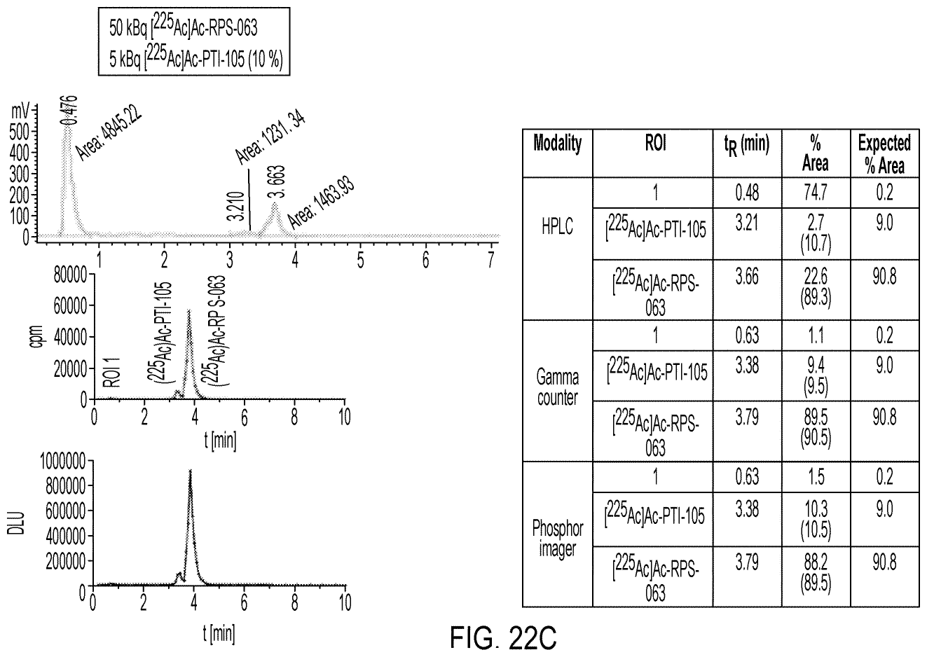

In this single replicate experiment, it was observed that the radiochromatogram acquired in real time by HPLC and the radiochromatograms reconstructed following gamma counting or phosphor imaging accurately reproduced the activity ratios in the [²²⁵Ac]Ac-PTI-105/[²²⁵Ac]Ac-RPS-063 mixtures, although the smallest activity of [²²⁵Ac]Ac-PTI-105 added was not detected by the HPLC (FIGS. 22A-22C). Exposure times of 5 min and 10 min on the phosphor screen provided the most accurate quantification of [²²⁵Ac]Ac-PTI-105, with the 2 min exposure time unable to detect this compound when it was added as a 1% activity ratio (FIGS. 22A-22C). When the ratio by activity was 50/50, both methods underestimated the contribution of [²²⁵Ac]Ac-PTI-105, likely due to time-dependent decomplexation of ²²⁵Ac. Nevertheless, as the presence of any impurity greater than 10% by activity would result in the production batch being rejected, the inaccuracies at higher proportions of impurity are not considered to be a limitation of this analytical method.

### Coupled HPLC-RadioTLC

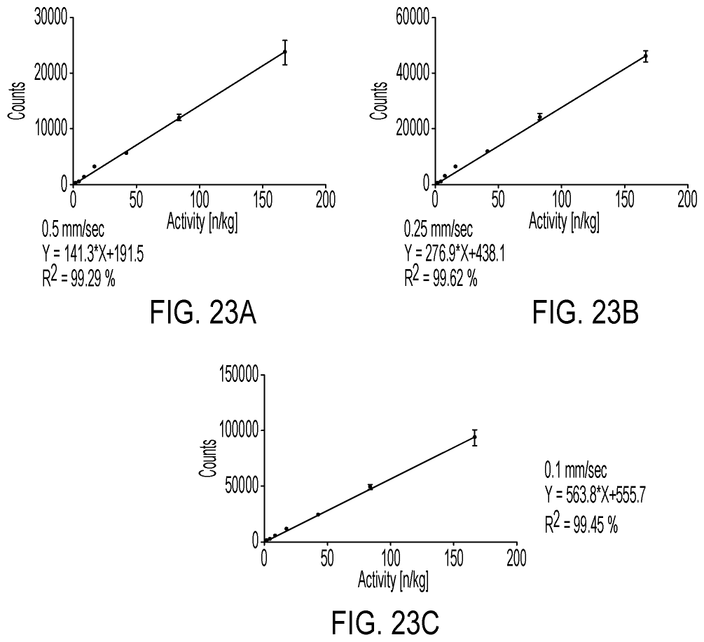

Recently, the possibility of coupling HPLC to radioTLC for determination of RCP for [²²⁵Ac]Ac-PSMA-617 was demonstrated (Ahn & Belanger, “Automated Radiolabeling and Handling of 177Lu- and 225Ac-PSMA-617 Using a Robotic Pipettor,” J. Label Compd. Radiopharm. 67:111-115 (2024), which is hereby incorporated by reference in its entirety). This method required successive scanning of 5 rows of a TLC plate, with manual adjustment of the plate in the scanner needed to move between rows. To streamline the analysis, a 3D printed insert containing 40 wells was developed to enable 40 fractions to be scanned in one single run. The maximum volume of each well was 100 μL. The insert was printed in nylon, but it was found that, while the material was solvent resistant, the layered print allowed the pipetted aliquots to permeate the material and contaminate adjacent wells. To prevent contamination, a few grains of liquid solidifier were introduced into the wells. This material effectively absorbed the aliquots. Using the 3D printed insert, calibration curves were derived for the radioTLC scanner at three different scan speeds (FIGS. 23A-23C). Linear regression analysis determined the LOD to be 500 Bq when the plate was scanned at 0.125 mm/s, 700 Bq for a scanning rate of 0.25 mm/s, and 1 kBq at 0.5 mm/s. The corresponding LOQs were on the order of 1 kBq. An injected activity of 5 kBq on the HPLC was sufficient to achieve S/N>100 when HPLC fractions were aliquoted into wells of the 3D printed insert. Lower injected activities were not tested to determine the minimum activity required.

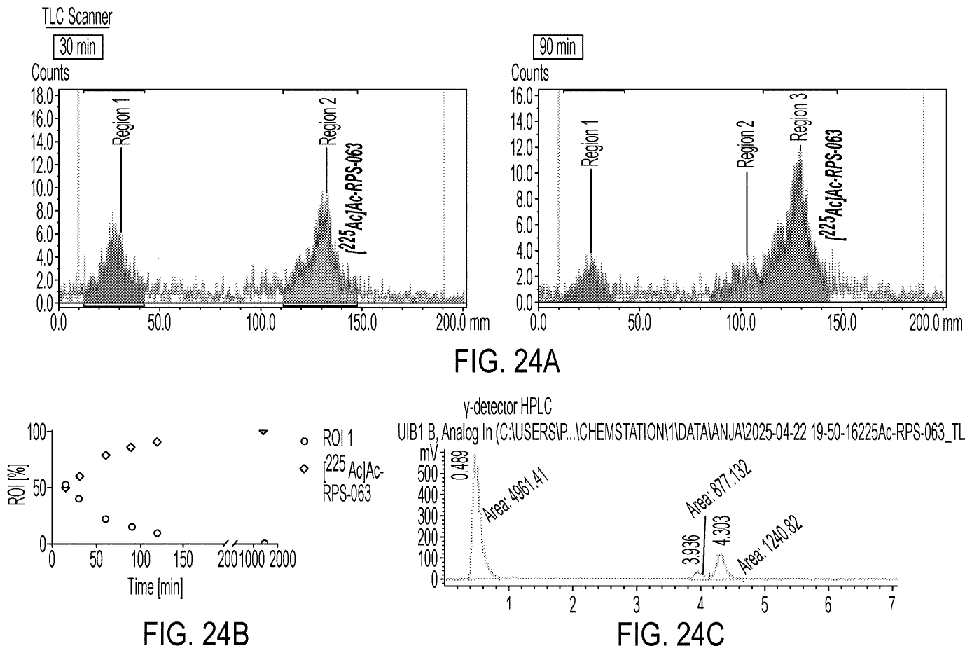

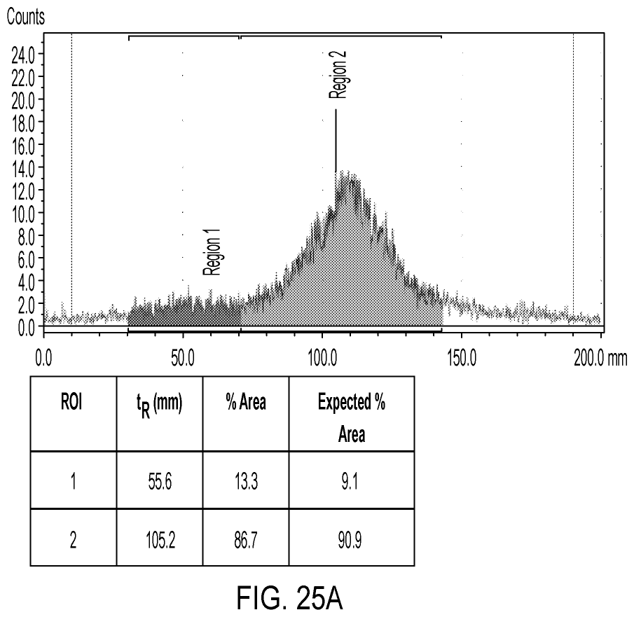

The ability of the 3D printed system to resolve peaks was tested by varying the number of empty wells between a 40 kBq aliquot and a 10 kBq aliquot and scanning speeds. When the signals were in close proximity (≤4 wells spacing, corresponding to 40 s difference in t_{R} on the HPLC), peak resolution exceeded 1 at a scanning rate of 0.125 mm/s. Resolution was comparable at faster scanning rates, but decreasing S/N ratios compromised the detection of the 10 kBq aliquot. Therefore, the requirement for slower scanning speed may become even more acute when lower activities are collected in the HPLC fractions. In agreement with pre-equilibrium measurements performed on the gamma counter and phosphor imager, serial scanning of the TLC insert beginning 15 min after fraction collected revealed that the apparent RCP of [²²⁵Ac]Ac-RPS-063 increased from 15 min to 48 h (FIGS. 24A-24C). Scanning was performed at a rate of 0.25 mm/s. Table 1 summarizes the parameters evaluated for each of the analytical techniques.

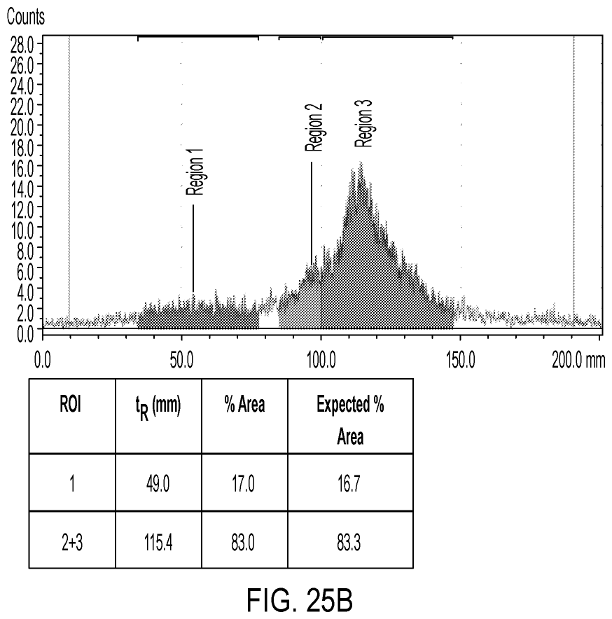

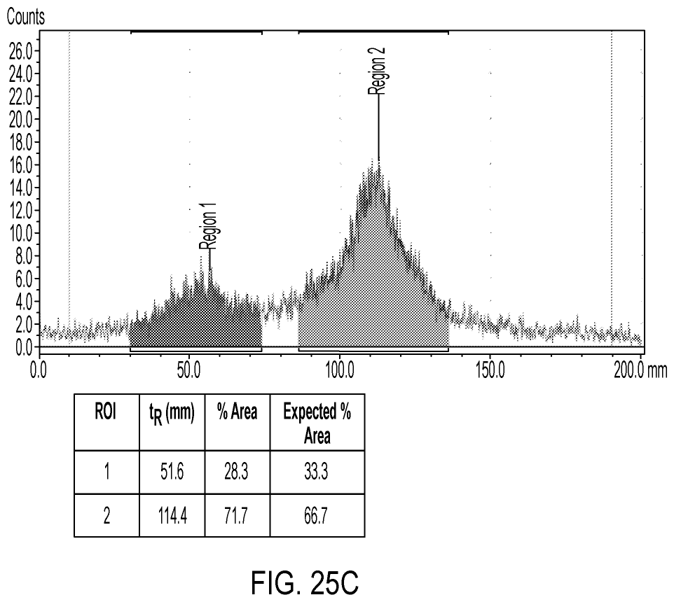

Finally, a similar pilot study was performed to establish the ability of the coupled HPLC-radioTLC method to quantify the amount of [²²⁵Ac]Ac-PTI-105 added to a solution of [²²⁵Ac]Ac-RPS-063. Fractions were collected at 10 s intervals from the HPLC to reduce the total number of fractions for analysis to 40, the number of wells in the 3D printed insert. At 10% activity basis [²²⁵Ac]Ac-PTI-105 (total activity 50 kBq [²²⁵Ac]Ac-RPS-063 and 5 kBq [225Ac]Ac-PTI-105), the impurity was visible at a scanning speed of 0.125 mm/s (FIGS. 25A-25C). In this single trial, the 20% impurity was accurately quantified (2.0% error) at a scanning speed of 0.125 mm/s, but not at faster scanning speeds. Once again, the method consistently underestimated the quantity of the 50% impurity.

### DISCUSSION

Pre-release assessment of RCP that identifies any radiolabeled impurities or radiolytic products is the best method of ensuring that patients undergoing TAT receive agents of the highest quality, and it is likely that regulatory agencies will require this analysis for new ²²⁵Ac TAT agents. It is also advantageous for pre-clinical experiments as a tool for minimizing the use of resources by ensuring the use of radiopharmaceuticals of sufficient quality. While, in principle, the workflow could be designed to administer the radiopharmaceutical hours after end-of-synthesis to allow RCP to be accurately determined, the highly ionizing alpha particles released by decay of ²²⁵Ac and its daughters could damage the delivery vector by radiolysis. While the risk of radiolysis is highest during synthesis, when the reaction is concentrated and heated (Hooijman et al., “Implementing Ac-225 Labelled Radiopharmaceuticals: Practical Considerations and (Pre-)clinical Perspectives,” EJNMMI Radiopharm. Chem. 9:9 (2024), which is hereby incorporated by reference in its entirety), the probability of radiolysis of the formulated product increases with time, even when the formulation solution contains components that suppress free radical production. Radiolysis is a random process that can generate degradation products that can closely resemble or substantially differ from the parent compound in structure, thereby leading to radiolabeled compounds with minimal chromatographic separation from the radiopharmaceutical product. Therefore, the LOD/LOQ of the analytical equipment and the analysis time and peak resolution were identified as the most important variables affecting accurate pre-release RCP assessment.

It was found that the limits of detection and quantification were one order of magnitude lower for HPLC-coupled gamma counting and HPLC-coupled phosphor imaging than HPLC alone or HPLC-coupled radioTLC. Using these modalities, sampling time could be sufficiently small so as to allow the reconstructed radiochromatogram to match the resolution of that acquired by HPLC, even when the injected activities are lower than required for HPLC. In the configuration described herein, the additional analysis time introduced by increased sampling frequency is relatively minor for phosphor imaging, involving just the time required to pipette additional aliquots, but more substantial for gamma counting (at least 75 s per additional fraction). Indeed, the time required for analysis is the major limitation of these methods with respect to pre-release determination of RCP. Even when gamma counting was restricted to a 180-240 keV energy window, counting of the HPLC fractions before post collection led to inaccurate quantification of RCP. This is attributed to down scatter of the higher energy gammas from ²¹³Bi into the ²²¹Fr energy window (Castillo et al., “Gamma Counting Protocols for the Accurate Quantification of ²²⁵Ac and ²¹³Bi Without the Need for a Secular Equilibrium Between Parent and Gamma-Emitting Daughter,” EJNMMI Radiopharmacy and Chemistry 7:28 (2022), which is hereby incorporated by reference in its entirety). As phosphor imaging cannot distinguish between emissions of different energies, it is inherently sensitive to disrupted radiochemical equilibrium and is suitably accurate after at least 90 min after spotting the aliquots.

HPLC coupled with radioTLC is comparatively rapid as an analytical method, detects the presence of unbound radiometal in the final product mixture, and is sufficient to identify the presence of a radiolabeled impurity when scanning speed on the Bioscan Mini-Scan is 0.125 mm/s. However, accurate quantification of the impurity using reasonable quantities of analyte—especially when the impurity is less than 20% by activity—may require an alternative method such as phosphor imaging or gamma counting. The major limitation of radioTLC in this context is its modest peak resolution. It was found that at least 4 empty wells between the tail of one peak and the front of the next were necessary to prevent peak overlap in the radiochromatogram when the plate was scanned at 0.125 mm/s. In the system described herein, for which HPLC sampling time was 10 s, this translates to a difference in retention time of 40 s. Shorter sampling times would reduce the required difference in retention time but increase the number of inserts that would need to be scanned, thereby increasing the analysis time.

One objective of this study was to determine the minimum activity of ²²⁵Ac-labeled product required for QC analysis. This aim preserves as much of the labeled product as possible for research or clinical treatment, which is increasingly important given the rising costs of ²²⁵Ac, and allows production facilities to comply with regulatory agency limits on the activity that can be handled outside of a hot cell or shielded glove box. Larger analyte activities would be expected to decrease analysis time by reducing the counting time for each fraction on the gamma counter, reducing exposure time on the phosphor screen, and decreasing the scanning time on the radioTLC scanner. However, if impurities with similar retention times to the desired product are present in the product mixture, larger activities might result in poorer peak resolution and consequently less accurate RCP quantification.

The pilot study suggests that the radiochromatogram obtained in real time from the HPLC may be sufficient for identifying and quantifying radiolabeled impurities. Disruption of radiochemical equilibrium is problematic in the context of chromatography because the gamma emissions from ²²¹Fr and ²¹³Bi are the most prominent in the ²²⁵Ac decay chain. However, these daughter nuclides are liberated from RPS-063 (and PTI-105) due to recoil energy, leading to the disproportionately large peak detected at the solvent front. Therefore, HPLC will need to be paired with an alternative analytical method that enables analysis at secular equilibrium between ²²⁵Ac and ²²¹Fr to ensure that the peak at the solvent front does not arise from uncomplexed [²²⁵Ac]Ac³⁺. The peaks detected with t_{R}>3 min, however, represent compounds conjugated to radionuclides—most notably [²²⁵Ac]Ac-RPS-063, [²²⁵Ac]PTI-105, and trace levels of ²¹³Bi-conjugated analogues generated during synthesis-present at the time of analysis. The NaI scintillation detector that was employed detects gamma emissions with an energy of 20-680 keV. Detection efficiency is approximately 10% for low energy gammas and 16% for higher energy emissions. The energy spectrum of emissions cannot be measured using this detector, meaning that it is not possible to determine the decay(s) responsible for gammas detected. Nevertheless, it is hypothesized that most of the signal is due to the gamma emission (100 keV, 2.4%) and a recently described photopeak at 78 keV produced by the decay of ²²⁵Ac to ²²¹Fr, and, as such, directly reflects the relative proportions of each ²²⁵ Ac-labeled species in the product mixture without the need to use gamma emissions from ²²¹Fr as a proxy measurement. The half-life of ²²¹Fr is sufficiently long as to prevent substantial decay while the analyte is passing by the radiodetector at a rate of 2 mL/min, meaning that contributions from ²²¹Fr should be minimal. Similarly, while other daughters in the ²²⁵Ac decay chain emit gammas with energies of approximately 80 keV, it may be similarly unlikely that these decays occur during the few seconds in which the analyte passes through the flow cell. Finally, even if decay of ²¹³Bi significantly contributes to the gamma emissions detected by the NaI scintillation detector, the relative proportions of ²¹³Bi-labeled species should reflect the ratios of ²²⁵Ac-labeled species in the model system described herein because both RPS-063 and PTI-105 contain DOTA. Taken together, these observations suggest that, for the model system disclosed herein, the HPLC chromatogram can be used to quantify the relative—but not absolute—amount of radiolabeled impurity as long as sufficient activity is injected on the column.

### Conclusions

The low limits of detection and quantification of gamma counting and phosphor imaging permit the most accurate quantification of radiochemical purity of ²²⁵Ac-labeled radiopharmaceuticals when low activities of the product are subjected to HPLC. Nevertheless, these quantification methods remain time consuming even under optimal conditions. By contrast, HPLC coupled to radioTLC allows RCP to be determined within 4 h of end-of-synthesis, potentially allowing its use as a pre-release QC assay. Despite innovations such as 3D printed inserts for commercial TLC scanners to streamline sample analysis, this method is limited by modest resolution and the requirement for higher activities of analyte. Intriguingly, findings support the use of the HPLC radiochromatogram alone for quantifying radiolabeled impurities.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A platform device for scanning HPLC fractions with a radio-thin layer chromatography (radioTLC) scanner, said platform device comprising:
a moving stage; and
a disposable insert, wherein the disposable insert comprises a plurality of wells capable of receiving aliquots of HPLC fractions, and wherein the disposable insert is configured to fit inside the moving stage.

2. The platform device of claim 1 further comprising:
a cover, wherein the cover fits over the insert.

3. The platform device of claim 1, wherein the platform comprises a chemically resistant material.

4. The platform device of claim 3, wherein the chemically resistant material is nylon 12 or polypropylene.

5. The platform device of claim 1, wherein each of the disposable wells is capable of holding between 1 μL and 500 μL of a solution.

6. The platform device of claim 1, wherein the disposable insert comprises solvent-resistant materials.

7. The platform device of claim 1, wherein each of the plurality of wells is lined with an absorbing material.

8. A method of assessing purity of a radio-labeled compound comprising a decay chain, said method comprising:
subjecting a sample comprising a radio-labeled compound comprising a decay chain to HPLC analysis to produce a collection of fractions and an HPLC chromatogram;
applying an aliquot from one or more of the fractions to the platform device of claim 1; and
subjecting the platform device to a radioTLC scanner to construct an HPLC radiochromatogram to identify the radio-labeled compound isolated from impurities in the sample.

9. The method of claim 8 further comprising:
storing the platform device until equilibrium is reached between a parent radionuclide present in the decay chain and one or more daughter radionuclide(s) generated from the parent radionuclide, wherein said storing is carried out prior to subjecting the platform device to the radioTLC scanner.

10. The method of claim 8, wherein said constructing the HPLC radiochromatogram comprises:
acquiring a radioTLC chromatogram from the radioTLC scanner, wherein the radioTLC chromatogram comprises one or more peaks corresponding to radioactivity; and
comparing the one or more peaks of the radioTLC chromatogram with the HPLC chromatogram to identify the radio-labeled compound.

11. The method of claim 8, wherein the radio-labeled compound is selected from the group consisting of a small molecule, peptide or peptidomimetic radiopharmaceutical, a radio-labeled antibody, a radio-labeled macromolecule, or a radio-labeled nanoparticle.

12. The method of claim 8, wherein the parent radionuclide is selected from the group consisting of ²²⁵Ac, ¹³⁴Ce, ²¹²Pb, and ²²⁷Th.

13.-16. (canceled)

17. The method of claim 8, wherein said applying comprises:
transferring an aliquot of one of the fractions to a well in the disposable insert; and
placing the disposable insert into the moving stage.

18. A method of assessing purity of a radio-labeled compound comprising a decay chain, said method comprising:
subjecting a sample comprising a radio-labeled compound comprising a decay chain to HPLC analysis to produce a collection of fractions and an HPLC chromatogram;
subjecting an aliquot from one or more of the fractions to a radioTLC scanner to construct an HPLC radiochromatogram to identify the radio-labeled compound isolated from impurities in the sample.

19. The method of claim 18 further comprising:
bringing a parent radionuclide present in the decay chain and one or more daughter radionuclide(s) generated from the parent radionuclide to equilibrium prior to subjecting to the radioTLC scanner.

20. The method of claim 18, wherein said constructing the HPLC radiochromatogram comprises:
acquiring a radioTLC chromatogram from the radioTLC scanner, wherein the radioTLC chromatogram comprises one or more peaks corresponding to radioactivity; and
comparing the one or more peaks of the radioTLC chromatogram with the HPLC chromatogram to identify the radio-labeled compound.

21. The method of claim 18, wherein the radio-labeled compound is selected from the group consisting of a small molecule, peptide or peptidomimetic radiopharmaceutical, a radio-labeled antibody, a radio-labeled macromolecule, or a radio-labeled nanoparticle.

22. The method of claim 18, wherein the parent radionuclide is selected from the group consisting of ²²⁵Ac, ¹³⁴Ce, ²¹²Pb, and ²²⁷Th.

23. The method of claim 18, wherein said subjecting an aliquot from one or more of the fractions comprises:
applying an aliquot of each fraction to a well in a substrate.

24. (canceled)

25. The method of claim 18, wherein the aliquot comprises 1 to 500 μL.

26.-27. (canceled)
